(19) United States
(12) Patent Application Publication
(10) Pub. No.: US 2026/0164428 A1
(43) Pub. Date: Jun. 11, 2026

(54) POWER EFFICIENT UPLINK SCHEDULING

(71) Applicant: QUALCOMM Incorporated, San Diego, CA (US)

(72) Inventors: Diana MAAMARI, San Diego, CA (US); Gabi SARKIS, San Diego, CA (US); Jing JIANG, San Diego, CA (US); Jae Ho RYU, San Diego, CA (US)

(21) Appl. No.: 18/976,296

(22) Filed: Dec. 10, 2024

(51) Int. Cl. H04W 72/1268; H04L 5/00

(52) U.S. Cl. CPC H04W 72/1268; H04L 5/0048

(57) ABSTRACT

Methods, systems, and devices for wireless communications are described. A user equipment (UE) may support power efficient scheduling to reduce power expenditure and conserve battery life, including power efficient scheduling that reduces the likelihood that the UE enters a high power state to support scheduled uplink transmissions. In some aspects, the UE may receive an indication of a configuration of a reduced peak throughput mode (e.g., a power efficient scheduling) for uplink communications at the UE, which may indicate a presence of minimum time gaps between consecutive uplink communications, a lack of aperiodic sounding reference signaling (A-SRS) triggering, and a lack of dynamic grants. The UE may then receive, in accordance with the configuration of the reduced peak throughput mode, control signaling that schedules one or more uplink messages, and may transmit, while operating in accordance with the reduced peak throughput mode, the one or more uplink messages.

### FIELD OF TECHNOLOGY

The following relates to wireless communications, including power efficient uplink scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving an indication of a configuration of a reduced peak throughput mode for uplink communications at the UE, the reduced peak throughput mode being indicative of a presence of minimum time gaps between consecutive uplink communications, a lack of aperiodic sounding reference signaling (A-SRS) triggering, and a lack of dynamic grants, receiving, in accordance with the configuration of the reduced peak throughput mode, control signaling that schedules one or more uplink messages, and transmitting, while operating in accordance with the reduced peak throughput mode, the one or more uplink messages based on the control signaling.

A UE for wireless communications is described. The UE may include one or more memories storing processor executable code, and one or more processors coupled with the one or more memories. The one or more processors may individually or collectively be operable to execute the code to cause the UE to receive an indication of a configuration of a reduced peak throughput mode for uplink communications at the UE, the reduced peak throughput mode being indicative of a presence of minimum time gaps between consecutive uplink communications, a lack of A-SRS triggering, and a lack of dynamic grants, receive, in accordance with the configuration of the reduced peak throughput mode, control signaling that schedules one or more uplink messages, and transmit, while operating in accordance with the reduced peak throughput mode, the one or more uplink messages based on the control signaling.

Another UE for wireless communications is described. The UE may include means for receiving an indication of a configuration of a reduced peak throughput mode for uplink communications at the UE, the reduced peak throughput mode being indicative of a presence of minimum time gaps between consecutive uplink communications, a lack of A-SRS triggering, and a lack of dynamic grants, means for receiving, in accordance with the configuration of the reduced peak throughput mode, control signaling that schedules one or more uplink messages, and means for transmitting, while operating in accordance with the reduced peak throughput mode, the one or more uplink messages based on the control signaling.

A non-transitory computer-readable medium storing code for wireless communications is described. The code may include instructions executable by one or more processors to receive an indication of a configuration of a reduced peak throughput mode for uplink communications at the UE, the reduced peak throughput mode being indicative of a presence of minimum time gaps between consecutive uplink communications, a lack of A-SRS triggering, and a lack of dynamic grants, receive, in accordance with the configuration of the reduced peak throughput mode, control signaling that schedules one or more uplink messages, and transmit, while operating in accordance with the reduced peak throughput mode, the one or more uplink messages based on the control signaling.

In some examples of the method, UEs, and non-transitory computer-readable medium described herein, receiving the indication of the configuration of the reduced peak throughput mode may include operations, features, means, or instructions for receiving one or more messages indicative of a lack of A-SRS scheduling, or an A-SRS scheduling having a time delay between downlink control signaling and a scheduled uplink transmission that may be greater than a minimum scheduling offset.

In some examples of the method, UEs, and non-transitory computer-readable medium described herein, the minimum scheduling offset for the A-SRS scheduling may be based on one or more capabilities of the UE, the one or more capabilities including at least one of a UE assistance information (UAI) signaling capability, a medium access control-control element (MAC-CE) signaling capability, or an uplink control information (UCI) signaling capability.

In some examples of the method, UEs, and non-transitory computer-readable medium described herein, receiving the indication of the configuration of the reduced peak throughput mode may include operations, features, means, or instructions for receiving one or more messages indicative of a periodic sounding reference signal (P-SRS) scheduling that may be in accordance with the reduced peak throughput mode.

In some examples of the method, UEs, and non-transitory computer-readable medium described herein, the lack of dynamic grants includes at least one of a lack of dynamic grant scheduling, or a dynamic grant scheduling having a time delay between downlink control signaling and a scheduled uplink transmission that may be greater than a minimum scheduling offset.

In some examples of the method, UEs, and non-transitory computer-readable medium described herein, the minimum scheduling offset for the dynamic grant scheduling may be based on one or more capabilities of the UE, the one or more capabilities including at least one of a UAI signaling capability, a MAC-CE signaling capability, or a UCI signaling capability.

In some examples of the method, UEs, and non-transitory computer-readable medium described herein, receiving the indication of the configuration of the reduced peak throughput mode may include operations, features, means, or instructions for receiving one or more messages indicative of that a threshold time gap may be satisfied between consecutive scheduled uplink grants.

In some examples of the method, UEs, and non-transitory computer-readable medium described herein, receiving the indication of the configuration of the reduced peak throughput mode may include operations, features, means, or instructions for receiving one or more messages indicative of a configured grant scheduling with a lack of retransmissions, or a configured grant scheduling with retransmissions and a time delay between downlink control signaling and a scheduled uplink transmission that may be greater than a minimum scheduling offset.

Some examples of the method, UEs, and non-transitory computer-readable medium described herein may further include operations, features, means, or instructions for receiving an indication of an initial resource allocation for transmission of the one or more uplink messages, where the control signaling that schedules the one or more uplink messages indicates a resource allocation within the initial resource allocation.

In some examples of the method, UEs, and non-transitory computer-readable medium described herein, the initial resource allocation includes a bandwidth part allocation or a physical resource block segment.

In some examples of the method, UEs, and non-transitory computer-readable medium described herein, receiving the indication of the configuration of the reduced peak throughput mode may include operations, features, means, or instructions for receiving one or more sounding reference signal (SRS) trigger messages that trigger wideband SRS transmission by the UE, where a quantity of consecutive SRS trigger messages received as part of the one or more SRS trigger messages may be less than a threshold quantity.

In some examples of the method, UEs, and non-transitory computer-readable medium described herein, receiving one or more SRS trigger messages may include operations, features, means, or instructions for receiving discontinuous SRS trigger messages based on one or more capabilities of the UE, where each SRS trigger message may be separated by a threshold quantity of slots.

In some examples of the method, UEs, and non-transitory computer-readable medium described herein, receiving the control signaling that schedules the one or more uplink messages may include operations, features, means, or instructions for receiving control signaling that schedules one or more uplink configured grant messages on a first cell and one or more SRS messages on a second cell, where transmitting the one or more uplink messages includes and transmitting the one or more SRS messages on the first cell based on a threshold timeline being satisfied for cancellation of the one or more uplink configured grant messages, where the one or more uplink configured grant messages may be dropped in accordance with the reduced peak throughput mode.

In some examples of the method, UEs, and non-transitory computer-readable medium described herein, receiving the control signaling that schedules the one or more uplink messages may include operations, features, means, or instructions for receiving control signaling that schedules one or more SRS messages on a first cell and one or more channel state information messages or uplink configured grant messages on a second cell, where transmitting the one or more uplink messages includes and transmitting the one or more channel state information messages or uplink configured grant messages on the second cell, where the one or more SRS messages may be dropped in accordance with the reduced peak throughput mode.

In some examples of the method, UEs, and non-transitory computer-readable medium described herein, receiving the control signaling that schedules the one or more uplink messages may include operations, features, means, or instructions for receiving control signaling that schedules one or more SRS messages on a first cell and one or more dynamic grant uplink messages on a second cell, where transmitting the one or more uplink messages includes and transmitting the one or more dynamic grant uplink messages on the second cell, where the one or more SRS messages may be dropped in accordance with the reduced peak throughput mode.

In some examples of the method, UEs, and non-transitory computer-readable medium described herein, receiving the control signaling that schedules the one or more uplink messages may include operations, features, means, or instructions for receiving control signaling that schedules one or more SRS messages on a first cell and one or more uplink control messages on a second cell, where transmitting the one or more uplink messages includes and transmitting the one or more uplink control messages on the second cell, where the one or more SRS messages may be dropped in accordance with the reduced peak throughput mode.

In some examples of the method, UEs, and non-transitory computer-readable medium described herein, receiving the control signaling that schedules the one or more uplink messages may include operations, features, means, or instructions for receiving control signaling that schedules one or more SRS messages on a first cell and one or more uplink messages on a second cell, where transmitting the one or more uplink messages includes and transmitting the one or more uplink messages on the second cell, where transmission of the one or more SRS messages may be delayed one or more transmission cycles based on the one or more uplink messages having a higher priority than the one or more SRS messages.

In some examples of the method, UEs, and non-transitory computer-readable medium described herein, receiving the indication of the configuration of the reduced peak throughput mode may include operations, features, means, or instructions for receiving one or more messages indicative of an uplink preparation timeline for the UE in the reduced peak throughput mode being greater than a default uplink preparation timeline for the UE in a non-reduced peak throughput mode.

In some examples of the method, UEs, and non-transitory computer-readable medium described herein, the uplink preparation timeline in the reduced peak throughput mode includes the default uplink preparation timeline plus an applied timing offset.

In some examples of the method, UEs, and non-transitory computer-readable medium described herein, the presence of minimum time gaps between consecutive uplink communications may be based on semi-static grants with the lack of dynamic grants, the lack of A-SRS triggering, or both.

A method for wireless communications by a network entity is described. The method may include outputting an indication of a configuration of a reduced peak throughput mode for uplink communications from a UE, the reduced peak throughput mode being indicative of a presence of minimum time gaps between consecutive uplink communications, a lack of A-SRS triggering, and a lack of dynamic grants, outputting, in accordance with the configuration of the reduced peak throughput mode, control signaling that schedules one or more uplink messages, and obtaining the one or more uplink messages based on the control signaling.

A network entity for wireless communications is described. The network entity may include one or more memories storing processor executable code, and one or more processors coupled with the one or more memories. The one or more processors may individually or collectively be operable to execute the code to cause the network entity to output an indication of a configuration of a reduced peak throughput mode for uplink communications from a UE, the reduced peak throughput mode being indicative of a presence of minimum time gaps between consecutive uplink communications, a lack of A-SRS triggering, and a lack of dynamic grants, output, in accordance with the configuration of the reduced peak throughput mode, control signaling that schedules one or more uplink messages, and obtain the one or more uplink messages based on the control signaling.

Another network entity for wireless communications is described. The network entity may include means for outputting an indication of a configuration of a reduced peak throughput mode for uplink communications from a UE, the reduced peak throughput mode being indicative of a presence of minimum time gaps between consecutive uplink communications, a lack of A-SRS triggering, and a lack of dynamic grants, means for outputting, in accordance with the configuration of the reduced peak throughput mode, control signaling that schedules one or more uplink messages, and means for obtaining the one or more uplink messages based on the control signaling.

A non-transitory computer-readable medium storing code for wireless communications is described. The code may include instructions executable by one or more processors to output an indication of a configuration of a reduced peak throughput mode for uplink communications from a UE, the reduced peak throughput mode being indicative of a presence of minimum time gaps between consecutive uplink communications, a lack of A-SRS triggering, and a lack of dynamic grants, output, in accordance with the configuration of the reduced peak throughput mode, control signaling that schedules one or more uplink messages, and obtain the one or more uplink messages based on the control signaling.

In some examples of the method, network entities, and non-transitory computer-readable medium described herein, outputting the indication of the configuration of the reduced peak throughput mode may include operations, features, means, or instructions for outputting one or more messages indicative of a lack of A-SRS scheduling, or an A-SRS scheduling having a time delay between downlink control signaling and a scheduled uplink transmission that may be greater than a minimum scheduling offset.

In some examples of the method, network entities, and non-transitory computer-readable medium described herein, outputting the indication of the configuration of the reduced peak throughput mode may include operations, features, means, or instructions for outputting one or more messages indicative of a periodic sounding reference signal (P-SRS) scheduling that may be in accordance with the reduced peak throughput mode.

In some examples of the method, network entities, and non-transitory computer-readable medium described herein, the lack of dynamic grants includes at least one of a lack of dynamic grant scheduling, or a dynamic grant scheduling having a time delay between downlink control signaling and a scheduled uplink transmission that may be greater than a minimum scheduling offset.

In some examples of the method, network entities, and non-transitory computer-readable medium described herein, outputting the indication of the configuration of the reduced peak throughput mode may include operations, features, means, or instructions for outputting one or more messages indicative of that a threshold time gap may be satisfied between consecutive scheduled uplink grants.

In some examples of the method, network entities, and non-transitory computer-readable medium described herein, outputting the indication of the configuration of the reduced peak throughput mode may include operations, features, means, or instructions for outputting one or more messages indicative of a configured grant scheduling with a lack of retransmissions, or a configured grant scheduling with retransmissions and a time delay between downlink control signaling and a scheduled uplink transmission that may be greater than a minimum scheduling offset.

Some examples of the method, network entities, and non-transitory computer-readable medium described herein may further include operations, features, means, or instructions for outputting an indication of an initial resource allocation for transmission of the one or more uplink messages, where the control signaling that schedules the one or more uplink messages indicates a resource allocation within the initial resource allocation.

In some examples of the method, network entities, and non-transitory computer-readable medium described herein, the initial resource allocation includes a bandwidth part allocation or a physical resource block segment.

In some examples of the method, network entities, and non-transitory computer-readable medium described herein, outputting the indication of the configuration of the reduced peak throughput mode may include operations, features, means, or instructions for outputting one or more SRS trigger messages that trigger wideband SRS transmission by the UE, where a quantity of consecutive SRS trigger messages outputted as part of the one or more SRS trigger messages may be less than a threshold quantity.

In some examples of the method, network entities, and non-transitory computer-readable medium described herein, outputting one or more SRS trigger messages may include operations, features, means, or instructions for outputting discontinuous SRS trigger messages, where each SRS trigger message may be separated by a threshold quantity of slots.

In some examples of the method, network entities, and non-transitory computer-readable medium described herein, outputting the indication of the configuration of the reduced peak throughput mode may include operations, features, means, or instructions for outputting one or more messages indicative of an uplink preparation timeline for the UE in the reduced peak throughput mode being greater than a default uplink preparation timeline for the UE in a non-reduced peak throughput mode.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1, 2, and 3 show examples of wireless communications systems that support power efficient uplink scheduling in accordance with one or more aspects of the present disclosure.

FIG. 4 shows an example of a process flow that supports power efficient uplink scheduling in accordance with one or more aspects of the present disclosure.

FIGS. 5 and 6 show block diagrams of devices that support power efficient uplink scheduling in accordance with one or more aspects of the present disclosure.

FIG. 7 shows a block diagram of a communications manager that supports power efficient uplink scheduling in accordance with one or more aspects of the present disclosure.

FIG. 8 shows a diagram of a system including a device that supports power efficient uplink scheduling in accordance with one or more aspects of the present disclosure.

FIGS. 9 and 10 show block diagrams of devices that support power efficient uplink scheduling in accordance with one or more aspects of the present disclosure.

FIG. 11 shows a block diagram of a communications manager that supports power efficient uplink scheduling in accordance with one or more aspects of the present disclosure.

FIG. 12 shows a diagram of a system including a device that supports power efficient uplink scheduling in accordance with one or more aspects of the present disclosure.

FIGS. 13 and 14 show flowcharts illustrating methods that support power efficient uplink scheduling in accordance with one or more aspects of the present disclosure.

### DETAILED DESCRIPTION

To reduce user equipment (UE) complexity, device power consumption, or both, a UE may support a reduced peak throughput mode or a reduced peak data rate, which may also be supported based on a reduced UE capability mode or a reduced capability mode. In some aspects, the reduced peak throughput mode may be achieved based on a set of scheduling restrictions. For example, a scheduling restriction may be achieved by a network entity “guaranteeing” or otherwise indicating that the UE may not be scheduled at all times (e.g., with consecutive uplink and/or downlink communications), or at times that the UE is scheduled, that there is a minimum time gap between subsequent downlink and uplink transmissions indicated by the scheduling. Additionally or alternatively, the reduced peak throughput mode may be achieved by allowing the UE to support a maximum data channel baseband bandwidth at certain time, but also configuring (e.g., guaranteeing) gaps following the maximum data channel baseband bandwidth. That is, the network entity may guarantee that the UE will not be scheduled with a physical downlink shared channel (PDSCH) reception and/or a physical uplink shared channel (PUSCH) transmission after the scheduled maximum data channel baseband bandwidth.

In such power efficient states, a network entity may transmit signaling that indicates that the UE will not be scheduled with sustained peak throughput (e.g., the maximum scheduled throughput will not exceed a threshold throughput limit), so that the UE may remain in a low power state. In some aspects, the signaling may include a throughput indication, for example, indicating that the maximum scheduled throughput will be less than or equal to a threshold throughput. Additionally, or alternatively, the signaling may indicate a relaxation of the feedback timeline, a relaxation of the PDSCH processing timeline and/or PUSCH preparation timeline, or that the UE may not be scheduled at all times (e.g., time gaps will be present between uplink channels and/or downlink channels such as PDSCH, PUSCH, sounding reference signaling (SRS), dynamic and/or configured channel state information reference signaling (CSI-RS), synchronization signal block (SSB) signaling, physical uplink control channel (PUCCH) signaling, or any combination thereof). In such examples, the presence of time gaps may indicate that the UE may not be expected to receive or transmit uplink or downlink channels for a time interval (e.g., corresponding to X milliseconds, X slots, or X symbols) following a scheduled transmission.

In some implementations (e.g., in new radio (NR) systems), the UE may receive dynamic scheduling leading to PUCCH or SRS transmission at any time, which may require the UE to use a different bandwidth or a different physical resource block (PRB) segment. The techniques described herein may support a reduced capability mode or reduced peak throughput mode in which the network entity guarantees (or otherwise indicates) a scheduling constraint for dynamic scheduling, including a minimum time gap between the dynamic scheduling and the scheduled uplink transmission, a minimum time gap between consecutive uplink transmissions (e.g., PUCCH or SRS transmissions which may require different bandwidth or PRB segments), or both.

In order to support power efficient scheduling for both uplink and downlink communications, the UE may support power efficient scheduling techniques that allow for the UE to remain in a low power state for both uplink and downlink scheduling. For example, in some implementations, the network entity may indicate that an uplink scheduling for the UE is a periodic scheduling (e.g., via periodic sounding reference signaling (P-SRS), configured grant (CG), or both), which may reduce or eliminate the UE receiving dynamic scheduling with a low latency requirement (e.g., a latency requirement that may conflict with a previous power efficient scheduling). Additionally, or alternatively, in examples that the uplink scheduling is a dynamic scheduling, the network entity may indicate that a quantity of time slots (e.g., K2) between when the UE receives the PDCCH that schedules an uplink data transmission and when the UE transmits the uplink data transmission is greater than a threshold quantity of time slots (e.g., Kmin), which may allow the UE sufficient time to remain in a low power state (if K2>Kmin). In some examples, the UE may support wideband SRS transmissions (e.g., for downlink channel sounding) if the SRS transmissions are periodic (or are spaced such that the UE has time to adjust in the low-power state). Additionally, or alternatively, the network entity may configure the uplink scheduling such that the UE may support power efficient scheduling, and such that the uplink scheduling does not drive the UE to a higher power state.

Aspects of the disclosure may be implemented to realize one or more potential advantages. For example, the techniques described herein may allow for power efficient scheduling for both uplink and downlink communications, such that the UE may remain in a power efficient communication mode while performing either or both uplink and downlink transmissions (rather than automatically switching from a lower power state to a higher power state based on an uplink scheduling). Additionally, or alternatively, the techniques described herein may allow for increased device coordination and more flexible scheduling, including increased feedback and processing timelines, flexible scheduling with time domain gaps, and support for both increased and reduced throughput for uplink and downlink scheduling.

Aspects of the disclosure are initially described in the context of wireless communications systems. Aspects of the disclosure are further illustrated by and described with reference to a process flow, apparatus diagrams, system diagrams, and flowcharts that relate to power efficient uplink scheduling.

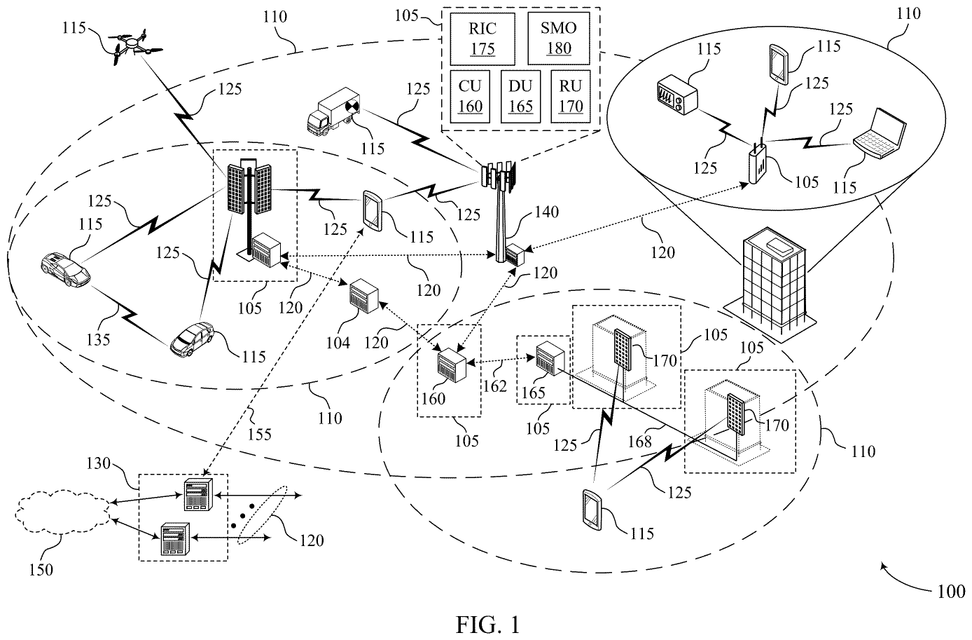

FIG. 1 shows an example of a wireless communications system 100 that supports power efficient uplink scheduling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support power efficient uplink scheduling as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A reduced capability UE 115 may support reduced energy/power consumption based on peak rate reduction. For example, a UE 115 may support an initial or baseline peak rate:

$$data rate ( in Mbps ) = {10}^{- 6} \cdot {\sum }_{j = 1}^{J} ( {v}_{L a y e r s}^{( j )} \cdot {Q}_{m}^{( j )} \cdot {z}^{( j )} \cdot {f}^{( j )} \cdot R \frac{{N}_{PRB}^{BW ( j ) , μ} \cdot 12}{{T}_{s}^{μ}} {( 1 - {OH}^{( j )} )}_{max} ) .$$

A network entity 105 may then indicate a reduced peak rate by indicating or signaling a scaling factor z^{(j)} which is less than one that the UE 115 may use to scale the peak rate. The network entity 105 may also indicate a processing timeline relaxation of N1+X ms (and a corresponding feedback timeline relaxation), and a set of DRX slots between scheduled PDSCHs which may allow for reduced peak rate for the UE 115. The UE 115 may support the reduced peak rate as:

$$data rate ( in Mbps ) = 1 {0}^{- 6} \cdot {\sum }_{j = 1}^{J} ( {v}_{Layers}^{( j )} \cdot {Q}_{m}^{( j )} \cdot {f}^{( j )} \cdot R \frac{{N}_{PRB}^{BW ( j ) , μ} \cdot 12}{{z}^{( j )} {T}_{s}^{μ}} {( 1 - {OH}^{( j )} )}_{max} ) .$$

In some aspects, the set of DRX slots between scheduled PDSCHs may be gap slots that may be scheduled separately from the respective PDSCHs. In some aspects, the UE 115 may indicate (e.g., via capability signaling, in one or more UE capability reports) how many PDSCHs that the network entity 105 may schedule consecutively (e.g., how many PDSCHs can occur back-to-back) before the UE 115 may expect a gap between PDSCHs.

A UE 115 may include a baseband (e.g., a baseband processor, a baseband radio processor) included in a chip or part of a chip in a network interface controller that manages different radio functions of the UE 115. In some implementations, the UE 115 may utilize different operational states, including different power and baseband processing states. For example, the UE 115 may support a first power state (e.g., a high radio frequency, low baseband power state), where the UE 115 may support a maximum or threshold radio frequency bandwidth with reduced throughput, one or more activated component carriers (e.g., a fraction of the total configured component carriers may be activated), an extended or relaxed feedback processing timeline, or any combination thereof.

Additionally, or alternatively, the UE 115 may support a second power state (e.g., a high radio frequency, high baseband power state), where the UE 115 may support a maximum radio frequency bandwidth, with one or more activated component carriers, a reduced or tight feedback processing timeline, or any combination thereof. Alternatively, the UE 115 may operate in accordance with the second power state when accommodating full buffer traffic, long bursts of traffic at or near peak throughput, high priority traffic, low latency traffic, among other conditions.

A UE 115 may have different capabilities to operate in both high-power states and low-power (e.g., power efficient) states based on different network scheduling types, latency requirements, and peak throughput.

In such power efficient states, a network entity 105 may transmit signaling that indicates that the UE will not be scheduled with sustained peak throughput (e.g., the maximum scheduled throughput will not exceed a threshold throughput limit), so that the UE may remain in a low power state. In some aspects, the signaling may include a throughput indication, for example, indicating that the maximum scheduled throughput will be less than or equal to a threshold throughput. In addition, the network entity 105 may indicate that a feedback timeline or a processing timeline is less than or equal to a threshold timeline, or that time gaps will be present between PDSCHs.

In some implementations, however, even if the network entity 105 indicates power efficient scheduling for downlink communications, the UE may still expend excess power for uplink scheduling. In order to support power efficient scheduling for both uplink and downlink communications, the UE 115 may support power efficient scheduling techniques that allow for the UE 115 to remain in a low power state for both uplink and downlink scheduling. For example, in some implementations, the network entity 105 may indicate that an uplink scheduling for the UE 115 is a periodic scheduling (e.g., via P-SRS or CG, or both), which may guarantee no dynamic grant). Additionally, or alternatively, in examples that the uplink scheduling is a dynamic scheduling, the network entity 105 may indicate that a quantity of time slots (e.g., K2) between when the UE 115 receives a downlink scheduling and a corresponding uplink data transmission is greater than a threshold quantity of time slots (e.g., K2 min), which may allow the UE 115 sufficient time to remain in a low power state (if K2>K2 min). In any case, the network entity 105 may configure the uplink scheduling such that the UE may support power efficient scheduling, and such that the uplink scheduling does not impact the power efficient scheduling for the UE 115.

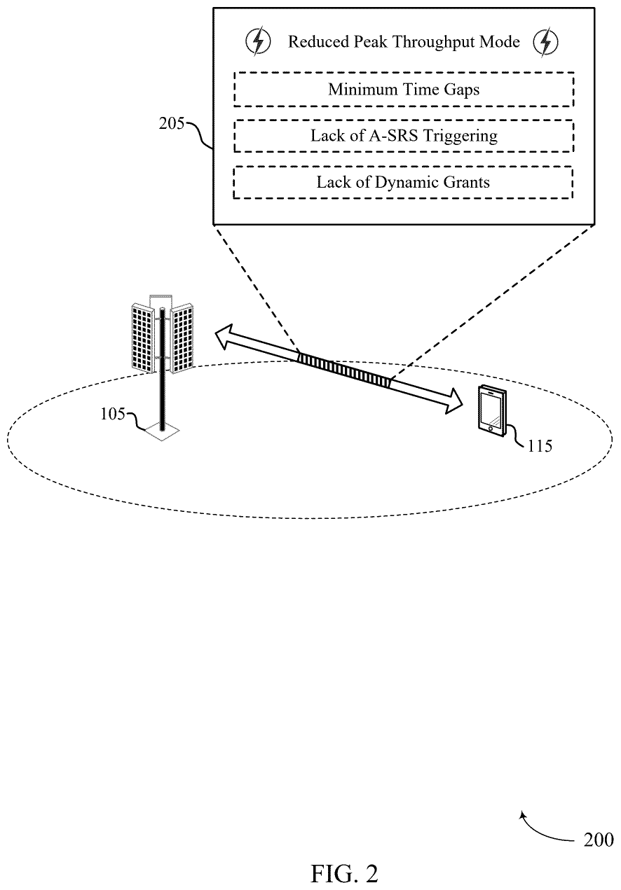

FIG. 2 shows an example of a wireless communications system 200 that supports power efficient uplink scheduling in accordance with one or more aspects of the present disclosure. For example, the wireless communications system 200 may support communications between a UE 115 and a network entity 105, each of which may be examples of UEs 115 and network entities 105 described with reference to FIG. 1. In some aspects, the UE 115 and the network entity 105 may support a reduced peak throughput mode for enhanced UE and network side power savings.

In some implementations, the UE 115 may support different capabilities for operation in both high power states and low-power (e.g., power efficient) states based on different scheduling, latency requirements, and traffic types. For example, for high throughput traffic and wideband scheduling, the UE 115 may enter a high power state associated with the wideband scheduling. Such high power modes may provide high performance, but may reduce power efficiency of the UE 115.

Additionally, or alternatively, the UE 115 may support power efficient scheduling for lower throughput traffic and narrowband scheduling, such that the UE 115 may enter a low power state or an “power efficient” state to save power. In such power efficient states, the network entity 105 may transmit an indication (e.g., via signaling 205) that the UE 115 will not be scheduled with sustained peak throughput (e.g., the maximum scheduled throughput will not exceed a threshold throughput limit), so that the UE 115 may refrain from ramping up to a highest power state. In some aspects, the indication that the network entity 105 transmits via signaling 205 may include a throughput indication, for example, indicating that the maximum scheduled throughput will be less than or equal to a threshold throughput. The indication included in signaling 205 may also include a feedback timeline or a processing timeline that is less than or equal to a threshold timeline. The indication may also indicate scheduled gaps between PDSCHs transmitted to the UE 115 (which may be indicative of the reduced throughput or power efficient scheduling when downlink data is less than a peak throughput and feedback timing is reduced). In some aspects, the power efficient scheduling (e.g., energy efficient scheduling, power efficient scheduling, time dilation) may allow for decoupling of radio frequency power and the baseband power (e.g., the UE 115 may move radio frequency power to a high power state while keeping the baseband power in a low power state), which may reduce overall device power expenditure.

In some implementations, however, even if the network entity 105 indicates (e.g., guarantees) power efficient scheduling (e.g., reduced peak throughput, relaxed feedback for receiving PDSCH and gaps between PDSCHs) for downlink communications, the UE 115 may enter a high power state for uplink scheduling. In some such cases, the UE 115 may support an uplink low power state such that the UE 115 remains in a low power (e.g., power efficient) state.

Additionally, or alternatively, in some implementations, the UE 115 may be granted an allocation of uplink bandwidth (e.g., an allocation of an uplink BWP). In order to transmit uplink communications, in some cases, the UE 115 may “zero” pad the allocation to reach the uplink BWP bandwidth size before performing IFFT, generating time-domain samples, and sending the samples from the UE baseband to the radio frequency (RF) front end for eventual uplink transmission. In such cases, the zero-padding may increase energy expenditure by the UE 115 since the UE 115 may transfer relatively more time domain samples to the RF frontend (e.g., relative to if the time domain samples were matched to the allocation without the zero-padding). In addition, if the UE 115 is scheduled with a tight timeline for grant-based uplink transmissions (e.g., a timeline that is not relaxed in accordance with a power efficient scheduling, such as for dynamic scheduling for physical uplink control channel (PUCCH) or SRS), then the UE 115 may not have sufficient time to adjust up-sampling processes in order to satisfy the tight timeline. In such cases, the network entity 105 may indicate uplink scheduling that allows the UE 115 to support uplink communications while remaining in a low power state.

In order to support reduced power consumption, the UE 115 may support power efficient scheduling techniques (e.g., reduced peak throughput, relaxed feedback timeline, among other power efficient scheduling characteristics) for both uplink and downlink communications, and may also support reduced rate time domain sampling when downlink and/or uplink scheduling is a power efficient scheduling. For example, in some implementations, the network entity 105 may indicate (e.g., via signaling 205) that an uplink scheduling for the UE 115 is a periodic scheduling (e.g., P-SRS, CG-SRS, or both), which may reduce or eliminate the UE 115 receiving dynamic scheduling with a low latency requirement (e.g., a latency requirement that may drive the baseband of the UE 115 into a high power state) such as with aperiodic SRS (A-SRS). Additionally, or alternatively, in examples that the uplink scheduling is a dynamic scheduling, the network entity 105 may indicate that a quantity of time slots (e.g., K2) between when the UE 115 receives a PDCCH that schedules an uplink data transmission (e.g., a PUCCH, a PUSCH) and when the UE transmits the uplink transmission is greater than a threshold quantity of time slots (e.g., Kmin), which may allow the UE 115 sufficient time to remain in a low power state (if K2>Kmin). In some other implementations, the uplink scheduling for the UE 115 may be applicable for a narrower portion of the bandwidth (e.g., the uplink BWP allocated for the UE 115 may span a narrow portion of the total bandwidth, or may be within a threshold range of the total bandwidth) which may reduce the total amount of zero-padding performed by the UE 115. In some such implementations, the UE 115 may support wideband SRS transmissions (e.g., for downlink channel sounding) if the SRS transmissions are periodic (or are spaced such that the UE 115 has time to adjust in the low-power state). In addition, the network entity 105 may indicate a lack of dynamic grants, or may otherwise indicate a threshold time gap is satisfied between dynamic grants, or that the time between the dynamic grant and the scheduled uplink transmission satisfies a threshold time. In such examples described herein, the network entity 105 may configure the uplink scheduling such that the UE 115 may support power efficient scheduling, and such that the uplink scheduling does not drive the baseband of the UE 115 to a higher power state.

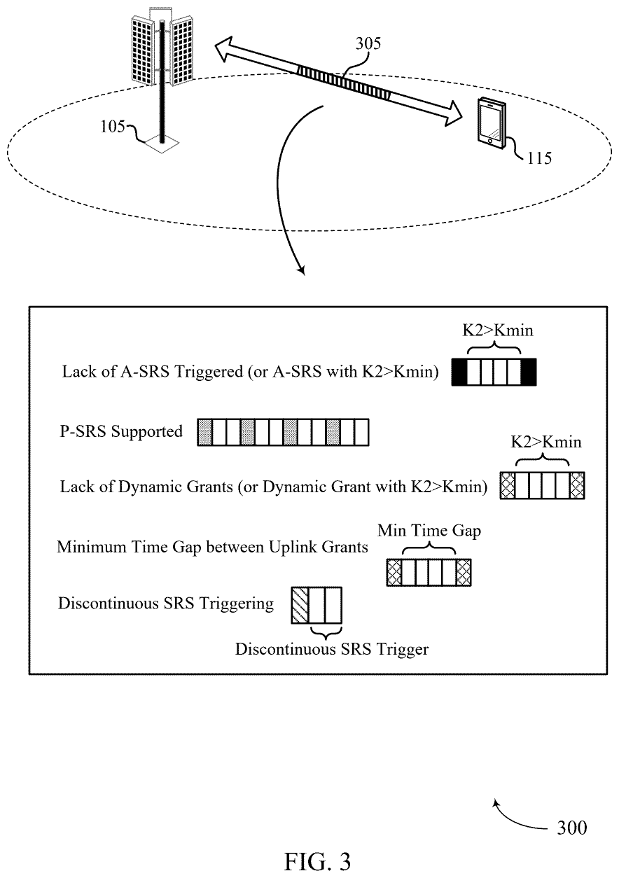

FIG. 3 shows an example of a wireless communications system 300 that supports power efficient uplink scheduling in accordance with one or more aspects of the present disclosure. For example, the wireless communications system 200 may support communications between a UE 115 and a network entity 105, each of which may be examples of UEs 115 and network entities 105 described with reference to FIGS. 1 and 2. In some aspects, the UE 115 and the network entity 105 may support a reduced peak throughput mode for enhanced UE and network side power savings.

In some implementations, the UE 115 may support carrier aggregation, and may be allocated uplink resources on a single component carrier. In such implementations, even if the UE 115 supports power efficient scheduling for downlink communications (e.g., reduced peak throughput, relaxed feedback, and time gaps between PDCCHs) in a low power state, uplink communications still may not comply with the power efficient scheduling.

In some aspects, the network entity 105 may indicate (e.g., via signaling 305) power efficient scheduling for the UE 115, which may include reduced peak throughput through time dilation (e.g., there may be a scheduling gap for a quantity X of slots following a wideband scheduling) and a relaxed feedback timeline. In order to avoid driving the baseband of the UE 115 from a low power state to a high power state as a result of uplink scheduling, the network entity 105 may further indicate various additional or alternative scheduling aspects to support the power efficient scheduling. In some examples, the network entity 105 may indicate (e.g., via signaling 305) that the UE 115 may not receive A-SRS triggering, which may allow the UE 115 to remain in a low power state (e.g., the UE 115 may not receive an A-SRS with a timeline that drives the baseband of the UE 115 into a high power state). In some other examples, the UE 115 may support A-SRS if a quantity of time slots (e.g., K2) between when the UE 115 receives a PDCCH that schedules the A-SRS and when the UE 115 transmits the A-SRS transmission is greater than a threshold quantity of time slots (e.g., Kmin), which may allow the UE 115 sufficient time to remain in a low power state (if K2>Kmin). In some such examples, the threshold quantity of time slots (e.g., Kmin) may be based on UE capability, and the UE 115 may indicate the UE capability via one or more capability messages (e.g., via UE assistance information (UAI) reporting, medium access control-control element (MAC-CE) signaling, uplink control information (UCI), or any combination thereof). In some other examples, the network entity 105 may indicate or allow narrowband or wideband P-SRS scheduling (without allowing A-SRS), which may give the UE 115 sufficient time for baseband and RF front end adjustments.

In some examples, the network entity 105 may indicate (or otherwise guarantee, via signaling 305) a lack of dynamic grants, or dynamic grant scheduling in which a quantity of time slots (e.g., K2) between when the UE 115 receives the dynamic grant and when the UE 115 transmits uplink communications scheduled by the dynamic grant is greater than a threshold quantity of time slots (e.g., Kmin), which may allow the UE 115 sufficient time to remain in a low power state (if K2>Kmin). In some such examples, the threshold quantity of time slots (e.g., Kmin) may be based on UE capability, and the UE 115 may indicate the UE capability via one or more capability messages (e.g., via UAI reporting, MAC-CE signaling, UCI, or any combination thereof). In some examples, the network entity 105 may indicate a threshold time gap (e.g., a minimum time gap) present between consecutive uplink grants which may allow the UE 115 to have sufficient time to reconfigure the RF frontend for uplink transmission.

In some examples, the network entity 105 may indicate (e.g., via signaling 305) support for uplink transmissions based on configured grants without retransmission, or with retransmission with K2>Kmin. In some examples, the network entity 105 may refrain from scheduling the UE 115 with PUCCHs that are allocated to a bandwidth or physical resource block (PRB) segment that is different from a bandwidth or PRB segment currently allocated for the UE 115 (e.g., the uplink scheduling that the UE 115 may receive may be within the same uplink BWP that the UE 115 is configured with at the time the UE 115 receives the uplink scheduling).

In some examples, the network entity 105 (e.g., via signaling 305) may trigger wideband SRS scheduling for the UE 115 (e.g., for channel estimation) when the UE 115 is in a low power state by indicating (e.g., guaranteeing) a restriction on the number of consecutive SRS triggers that will occur. For example, the network entity 105 may indicate discontinuous SRS triggers for a threshold quantity of slots (e.g., X slots) following the last SRS trigger that the UE 115 receives. That is, the UE 115 may receive one or more SRS triggers, and then may not receive SRS triggers for the threshold quantity of slots. In some aspects, the threshold quantity of slots may be based on UE capability, and the UE 115 may indicate the UE capability via one or more capability messages (e.g., via UAI reporting, MAC-CE signaling, UCI, or any combination thereof).

In some other implementations, the UE 115 may be allocated uplink resources on multiple component carriers. In such implementations, even if the UE 115 supports power efficient scheduling for downlink communications (e.g., reduced peak throughput, relaxed feedback, and time gaps between PDCCHs) in a low power state, the UE 115 may support multiple concurrent transmissions while the UE 115 operates in a low power state, and may support scheduling that complies with a power efficient scheduling for the UE 115. For example, the UE 115 may be configured with one or more priority rules for SRS dropping that allows for the UE 115 to remain in a power efficient scheduling state (e.g., if an SRS transmission on a target component carrier and uplink transmissions on other carries exceed capabilities of the UE 115 to stay in the low power state). In some examples, the UE 115 may support a priority rule that instructs the UE 115 to drop a configured grant PUSCH and prioritize a triggered SRS whenever a cancellation timeline is satisfied, where the cancellation timeline is based on the UE 115 being able to cancel the configured grant PUSCH within a threshold duration (e.g., N2) before the triggered SRS. In some examples, the UE 115 may support a priority rule that instructs the UE 115 to drop the SRS and prioritize CSI reporting or uplink configured grant scheduling. In some examples, the UE 115 may support a priority rule that instructs the UE 115 to drop the SRS and prioritize downlink grant PUSCHs. In some examples, the UE 115 may support a priority rule that instructs the UE 115 to drop the SRS and prioritize a PUCCH transmission. In some other examples, the UE 115 may follow a rule indicating that, instead of dropping the SRS, the UE 115 may delay the SRS trigger until the UE 115 has spare DRX cycles for uplink transmission.

In some implementations, when the network entity 105 indicates that the UE 115 is configured for power efficient scheduling (e.g., via signaling 305) including reduced peak throughput through time dilation (e.g., if the UE 115 is not scheduled for a quantity X of slots following a wideband scheduling) and with relaxed feedback, the network entity 105 may also indicate relaxation in the uplink preparation timeline (e.g., N2). For example, the network entity 105 may indicate that the UE 115 uses an N2 that is greater than a default N2 (where the default N2 may be a preparation timeline that is supported for non-power efficient scheduling). In some examples, the UE 115 may apply an indicated relaxed N2 value, or may apply an offset to the default N2 if wideband SRS is triggered while operating in a power-efficient scheduling state.

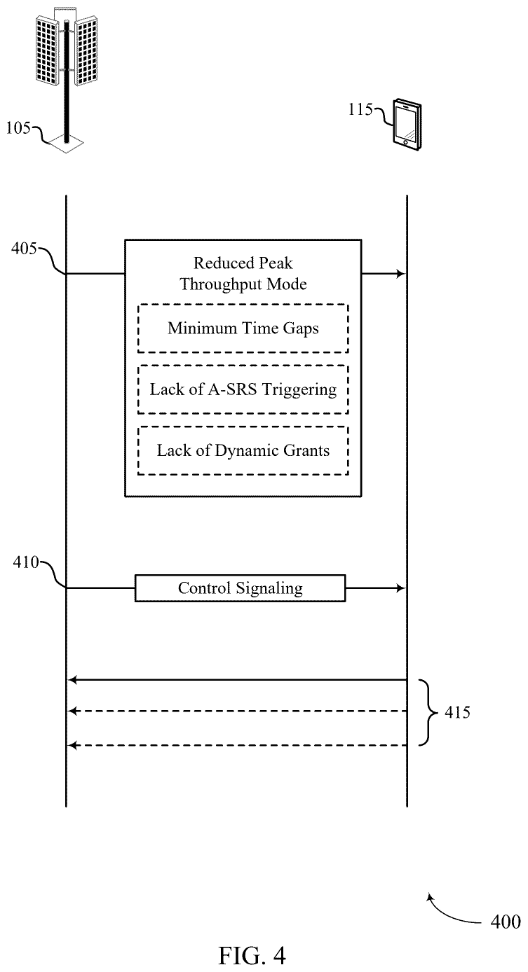

FIG. 4 shows an example of a process flow 400 that supports power efficient uplink scheduling in accordance with one or more aspects of the present disclosure. In some examples, process flow 400 may implement aspects of, or be implemented by aspects of, the wireless communications system 100, the wireless communications system 200, and the wireless communications system 300. In some aspects, the process flow 400 may include a UE 115 and a network entity 105 which may be examples of corresponding devices described with reference to FIGS. 1-3.

In the following description of the process flow 400, the operations between the network entity 105 and the UE 115 may be performed in different orders or at different times than the example shown. Some operations may also be omitted from the process flow 400, and other operations may be added to the process flow 400. In this example, the network entity 105 and the UE 115 may support techniques for power efficient uplink scheduling.

At 405, the UE 115 may receive an indication of a configuration of a reduced peak throughput mode for uplink communications at the UE 115, the reduced peak throughput mode being indicative of a presence of minimum time gaps between consecutive uplink communications, a lack of A-SRS triggering, and a lack of dynamic grants. In some aspects, the presence of minimum time gaps between consecutive uplink transmissions may be based on semi-static grants and a lack of dynamic grants, a lack of A-SRS triggering, or both.

In some examples, the indication of the configuration of the reduced peak throughput mode may include one or more messages indicative of a lack of A-SRS scheduling, or an A-SRS scheduling having a time delay between downlink control signaling and a scheduled uplink transmission that is greater than a minimum scheduling offset. In some examples, the UE 115 may transmit UE capability signaling (e.g., via UAI, MAC-CE, UCI, or any combination thereof), that indicates one or more time delays that the UE 115 is capable of supporting while remaining in a low power state. In some examples, the indication of the configuration of the reduced peak throughout mode may include one or more messages indicative of a P-SRS scheduling that is in accordance with the reduced peak throughput mode.

In some examples, the lack of dynamic grants may include a lack of dynamic grant scheduling (e.g., the UE 115 may not expect to receive dynamic grants) or a dynamic grant scheduling that has a time delay between downlink control signaling and a scheduled uplink transmission that is greater than a minimum scheduling offset. In some aspects, the threshold scheduling offset may be based on or configured in accordance with a UE capability (e.g., a scheduling offset that the UE 115 is capable of supporting), which the UE 115 may signal to the network entity 105 via UAI, MAC-CE, or UCI signaling.

In some examples, the indication of the configuration of the reduced peak throughput mode may include one or more messages that indicate a threshold gap being satisfied between consecutive scheduled uplink grants. In some examples, the indication of the configuration of the reduced peak throughput mode may include one or more messages indicative of a configured grant scheduling with a lack of retransmissions, or a configured grant scheduling with retransmissions and a time delay between downlink control signaling and a scheduled uplink transmission that is greater than a minimum scheduling offset.

In some examples, the indication of the configuration of the reduced peak throughput mode may include one or more SRS trigger messages that trigger wideband SRS transmission by the UE 115. In some aspects, a quantity of consecutive SRS trigger messages received as part of the one or more SRS trigger messages (during a time period) may be less than a threshold quantity. In some aspects, UE 115 may receive discontinuous SRS triggers, such that the time distance between which the UE 115 may receive respective discontinuous SRS triggers may be based on a UE capability.

In some examples, the indication of the configuration of the reduced peak throughput mode may include one or more messages indicative of an uplink preparation timeline for the UE 115 in the reduced peak throughput mode being greater than a default uplink preparation timeline for the UE 115 in a non-reduced peak throughput mode. In some aspects, the wherein the uplink preparation timeline in the reduced peak throughput mode is indicated by a single value, or is indicated as the default uplink preparation timeline plus an applied timing offset.

At 410, the UE 115 may receive, in accordance with the configuration of the reduced peak throughput mode, control signaling that schedules one or more uplink messages. In some examples, the UE 115 may receive an indication of an initial resource allocation (e.g., a BWP allocation, a PRB segment allocation, or both) for transmission of the one or more uplink messages such that the control signaling that schedules the one or more uplink messages indicates a resource allocation within the initial resource allocation.

At 415, the UE 115 may transmit, while operating in accordance with the reduced peak throughput mode, the one or more uplink messages based on the control signaling.

In some aspects, the UE 115 may receive control signaling that schedules one or more uplink configured grant messages on a first cell and one or more SRS messages on a second cell, and the UE 115 may transmit the one or more SRS messages on the first cell based on a threshold timeline being satisfied for cancellation of the one or more uplink configured grant messages, where the UE 115 drops (e.g., refrains from transmitting) the one or more uplink configured grant messages in accordance with the reduced peak throughput mode.

Additionally, or alternatively, the UE 115 may receive control signaling that schedules one or more SRS messages on a first cell and one or more CSI messages or uplink configured grant messages on a second cell. In such cases, the UE 115 may drop the one or more SRS messages (in accordance with the reduced peak throughput mode) and may transmit the one or more CSI messages or uplink configured grant messages on the second cell. Additionally, or alternatively, the UE 115 may receive control signaling that schedules one or more SRS messages on a first cell and one or more dynamic grant uplink messages on a second cell. In such cases, the UE 115 may drop the one or more SRS messages (in accordance with the reduced peak throughput mode) and may transmit the one or more dynamic grant uplink messages on the second cell. Additionally, or alternatively, the UE 115 may receive control signaling that schedules one or more SRS messages on a first cell and one or more uplink control channel (e.g., PUCCH) messages on a second cell. In such cases, the UE 115 may drop the one or more SRS messages (in accordance with the reduced peak throughput mode) and may transmit the one or more uplink control channel messages on the second cell.

In some examples, the UE 115 may receive control signaling that schedules the one or more SRS messages on the first cell, and one or more uplink messages on a second cell (e.g., configured grant, dynamic grant, CSI, control channel messages) that have a higher relative priority than the one or more SRS messages. In some such examples, the UE 115 may delay transmission of the one or more SRS messages on the first cell in order to first transmit the one or more uplink messages on the second cell.

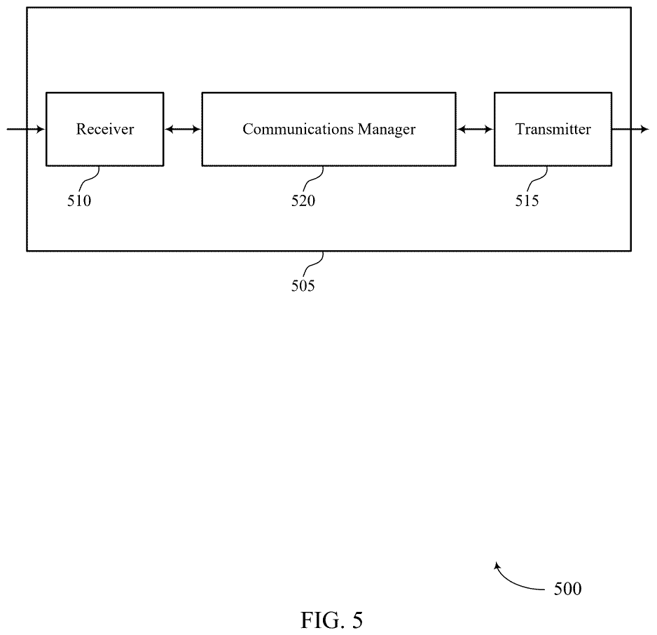

FIG. 5 shows a block diagram 500 of a device 505 that supports power efficient uplink scheduling in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to power efficient uplink scheduling). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to power efficient uplink scheduling). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of power efficient uplink scheduling as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving an indication of a configuration of a reduced peak throughput mode for uplink communications at the UE, the reduced peak throughput mode being indicative of a presence of minimum time gaps between consecutive uplink communications, a lack of A-SRS triggering, and a lack of dynamic grants. The communications manager 520 is capable of, configured to, or operable to support a means for receiving, in accordance with the configuration of the reduced peak throughput mode, control signaling that schedules one or more uplink messages. The communications manager 520 is capable of, configured to, or operable to support a means for transmitting, while operating in accordance with the reduced peak throughput mode, the one or more uplink messages based on the control signaling.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, more efficient utilization of communication resources, improved device coordination, improved coordination between uplink and downlink power efficient scheduling, and increased battery life.

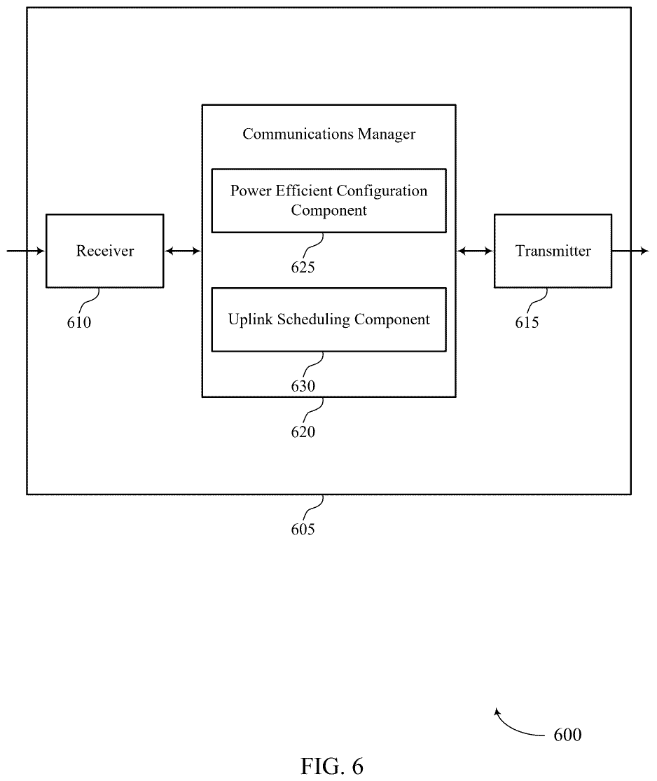

FIG. 6 shows a block diagram 600 of a device 605 that supports power efficient uplink scheduling in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to power efficient uplink scheduling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power efficient uplink scheduling). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of power efficient uplink scheduling as described herein. For example, the communications manager 620 may include a power efficient configuration component 625 an uplink scheduling component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The power efficient configuration component 625 is capable of, configured to, or operable to support a means for receiving an indication of a configuration of a reduced peak throughput mode for uplink communications at the UE, the reduced peak throughput mode being indicative of a presence of minimum time gaps between consecutive uplink communications, a lack of A-SRS triggering, and a lack of dynamic grants. The uplink scheduling component 630 is capable of, configured to, or operable to support a means for receiving, in accordance with the configuration of the reduced peak throughput mode, control signaling that schedules one or more uplink messages. The uplink scheduling component 630 is capable of, configured to, or operable to support a means for transmitting, while operating in accordance with the reduced peak throughput mode, the one or more uplink messages based on the control signaling.

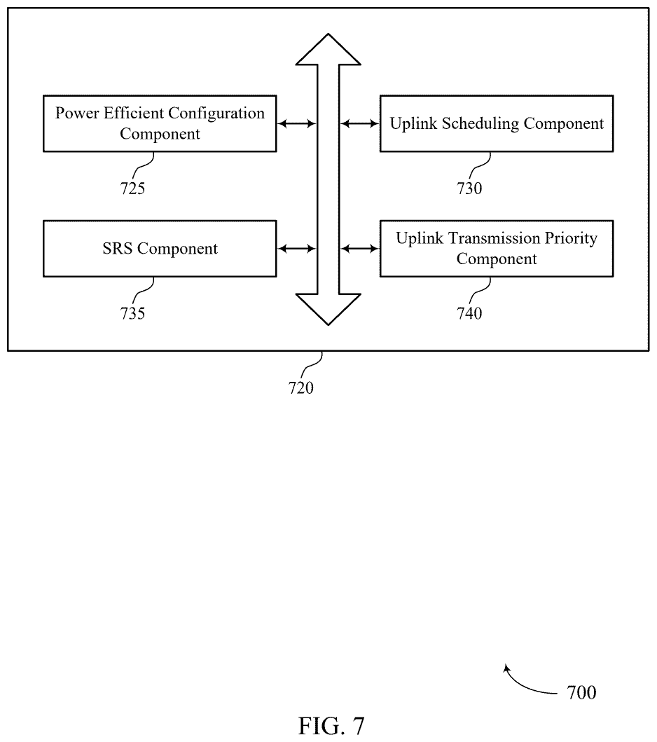

FIG. 7 shows a block diagram 700 of a communications manager 720 that supports power efficient uplink scheduling in accordance with one or more aspects of the present disclosure. The communications manager 720 may be an example of aspects of a communications manager 520, a communications manager 620, or both, as described herein. The communications manager 720, or various components thereof, may be an example of means for performing various aspects of power efficient uplink scheduling as described herein. For example, the communications manager 720 may include a power efficient configuration component 725, an uplink scheduling component 730, an SRS component 735, an uplink transmission priority component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The power efficient configuration component 725 is capable of, configured to, or operable to support a means for receiving an indication of a configuration of a reduced peak throughput mode for uplink communications at the UE, the reduced peak throughput mode being indicative of a presence of minimum time gaps between consecutive uplink communications, a lack of A-SRS triggering, and a lack of dynamic grants. The uplink scheduling component 730 is capable of, configured to, or operable to support a means for receiving, in accordance with the configuration of the reduced peak throughput mode, control signaling that schedules one or more uplink messages. In some examples, the uplink scheduling component 730 is capable of, configured to, or operable to support a means for transmitting, while operating in accordance with the reduced peak throughput mode, the one or more uplink messages based on the control signaling.

In some examples, to support receiving the indication of the configuration of the reduced peak throughput mode, the uplink scheduling component 730 is capable of, configured to, or operable to support a means for receiving one or more messages indicative of a lack of A-SRS scheduling, or an A-SRS scheduling having a time delay between downlink control signaling and a scheduled uplink transmission that is greater than a minimum scheduling offset. In some examples, the threshold scheduling offset for the A-SRS scheduling is based on one or more capabilities of the UE, the one or more capabilities including at least one of a UAI signaling capability, a MAC-CE signaling capability, or a UCI signaling capability.

In some examples, to support receiving the indication of the configuration of the reduced peak throughput mode, the uplink scheduling component 730 is capable of, configured to, or operable to support a means for receiving one or more messages indicative of a P-SRS scheduling that is in accordance with the reduced peak throughput mode. In some examples, the lack of dynamic grants includes at least one of a lack of dynamic grant scheduling, or a dynamic grant scheduling having a time delay between downlink control signaling and a scheduled uplink transmission that is greater than a minimum scheduling offset.

In some examples, the threshold scheduling offset for the dynamic grant scheduling is based on one or more capabilities of the UE, the one or more capabilities including at least one of a UAI signaling capability, a MAC-CE signaling capability, or a UCI signaling capability.

In some examples, to support receiving the indication of the configuration of the reduced peak throughput mode, the uplink scheduling component 730 is capable of, configured to, or operable to support a means for receiving one or more messages indicative of that a threshold time gap is satisfied between consecutive scheduled uplink grants. In some examples, to support receiving the indication of the configuration of the reduced peak throughput mode, the uplink scheduling component 730 is capable of, configured to, or operable to support a means for receiving one or more messages indicative of a configured grant scheduling with a lack of retransmissions, or a configured grant scheduling with retransmissions and a time delay between downlink control signaling and a scheduled uplink transmission that is greater than a minimum scheduling offset.

In some examples, the uplink scheduling component 730 is capable of, configured to, or operable to support a means for receiving an indication of an initial resource allocation for transmission of the one or more uplink messages, where the control signaling that schedules the one or more uplink messages indicates a resource allocation within the initial resource allocation. In some examples, the initial resource allocation includes a bandwidth part allocation or a physical resource block segment.

In some examples, to support receiving the indication of the configuration of the reduced peak throughput mode, the SRS component 735 is capable of, configured to, or operable to support a means for receiving one or more SRS trigger messages that trigger wideband SRS transmission by the UE, where a quantity of consecutive SRS trigger messages received as part of the one or more SRS trigger messages is less than a threshold quantity. In some examples, to support receiving one or more SRS trigger messages, the SRS component 735 is capable of, configured to, or operable to support a means for receiving discontinuous SRS trigger messages based on one or more capabilities of the UE, where each SRS trigger message is separated by a threshold quantity of slots.

In some examples, to support receiving the control signaling that schedules the one or more uplink messages, the uplink transmission priority component 740 is capable of, configured to, or operable to support a means for receiving control signaling that schedules one or more uplink configured grant messages on a first cell and one or more SRS messages on a second cell, where transmitting the one or more uplink messages includes. In some examples, to support receiving the control signaling that schedules the one or more uplink messages, the uplink transmission priority component 740 is capable of, configured to, or operable to support a means for transmitting the one or more SRS messages on the first cell based on a threshold timeline being satisfied for cancellation of the one or more uplink configured grant messages, where the one or more uplink configured grant messages are dropped in accordance with the reduced peak throughput mode.

In some examples, to support receiving the control signaling that schedules the one or more uplink messages, the uplink transmission priority component 740 is capable of, configured to, or operable to support a means for receiving control signaling that schedules one or more SRS messages on a first cell and one or more CSI messages or uplink configured grant messages on a second cell, where transmitting the one or more uplink messages includes. In some examples, to support receiving the control signaling that schedules the one or more uplink messages, the uplink transmission priority component 740 is capable of, configured to, or operable to support a means for transmitting the one or more CSI messages or uplink configured grant messages on the second cell, where the one or more SRS messages are dropped in accordance with the reduced peak throughput mode.

In some examples, to support receiving the control signaling that schedules the one or more uplink messages, the uplink transmission priority component 740 is capable of, configured to, or operable to support a means for receiving control signaling that schedules one or more SRS messages on a first cell and one or more dynamic grant uplink messages on a second cell, where transmitting the one or more uplink messages includes. In some examples, to support receiving the control signaling that schedules the one or more uplink messages, the uplink transmission priority component 740 is capable of, configured to, or operable to support a means for transmitting the one or more dynamic grant uplink messages on the second cell, where the one or more SRS messages are dropped in accordance with the reduced peak throughput mode.

In some examples, to support receiving the control signaling that schedules the one or more uplink messages, the uplink transmission priority component 740 is capable of, configured to, or operable to support a means for receiving control signaling that schedules one or more SRS messages on a first cell and one or more uplink control messages on a second cell, where transmitting the one or more uplink messages includes. In some examples, to support receiving the control signaling that schedules the one or more uplink messages, the uplink transmission priority component 740 is capable of, configured to, or operable to support a means for transmitting the one or more uplink control messages on the second cell, where the one or more SRS messages are dropped in accordance with the reduced peak throughput mode.

In some examples, to support receiving the control signaling that schedules the one or more uplink messages, the uplink transmission priority component 740 is capable of, configured to, or operable to support a means for receiving control signaling that schedules one or more SRS messages on a first cell and one or more uplink messages on a second cell, where transmitting the one or more uplink messages includes. In some examples, to support receiving the control signaling that schedules the one or more uplink messages, the uplink transmission priority component 740 is capable of, configured to, or operable to support a means for transmitting the one or more uplink messages on the second cell, where transmission of the one or more SRS messages is delayed one or more transmission cycles based on the one or more uplink messages having a higher priority than the one or more SRS messages.

In some examples, to support receiving the indication of the configuration of the reduced peak throughput mode, the uplink scheduling component 730 is capable of, configured to, or operable to support a means for receiving one or more messages indicative of an uplink preparation timeline for the UE in the reduced peak throughput mode being greater than a default uplink preparation timeline for the UE in a non-reduced peak throughput mode. In some examples, the uplink preparation timeline in the reduced peak throughput mode includes the default uplink preparation timeline plus an applied timing offset. In some examples, the presence of minimum time gaps between consecutive uplink communications is based on semi-static grants with the lack of dynamic grants, the lack of A-SRS triggering, or both.

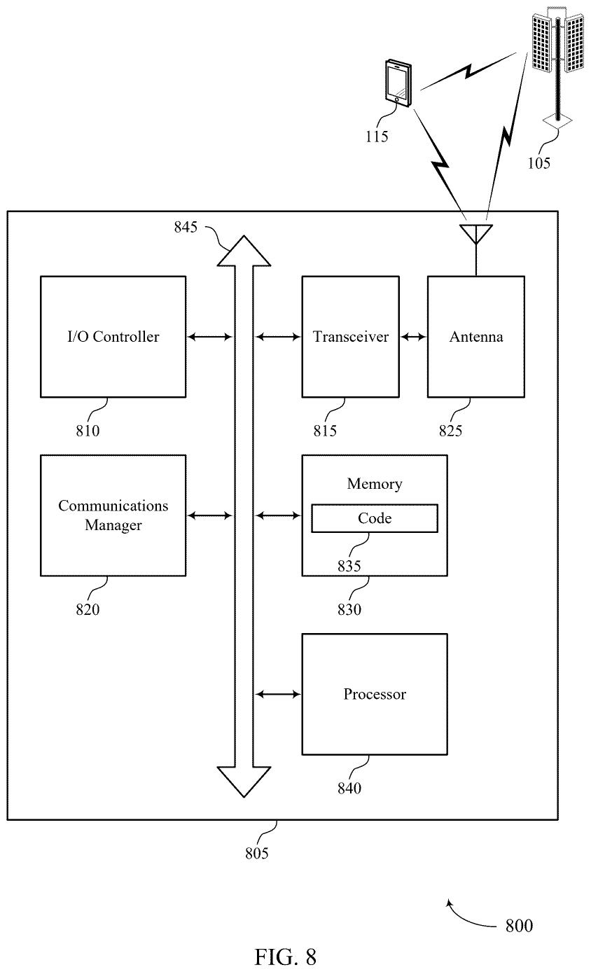

FIG. 8 shows a diagram of a system 800 including a device 805 that supports power efficient uplink scheduling in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting power efficient uplink scheduling). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving an indication of a configuration of a reduced peak throughput mode for uplink communications at the UE, the reduced peak throughput mode being indicative of a presence of minimum time gaps between consecutive uplink communications, a lack of A-SRS triggering, and a lack of dynamic grants. The communications manager 820 is capable of, configured to, or operable to support a means for receiving, in accordance with the configuration of the reduced peak throughput mode, control signaling that schedules one or more uplink messages. The communications manager 820 is capable of, configured to, or operable to support a means for transmitting, while operating in accordance with the reduced peak throughput mode, the one or more uplink messages based on the control signaling.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, improved UE baseband function, and improved coordination between uplink and downlink power efficient scheduling.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of power efficient uplink scheduling as described herein, or the at least one processor 840 and the at least one memory 830 may be otherwise configured to, individually or collectively, perform or support such operations.

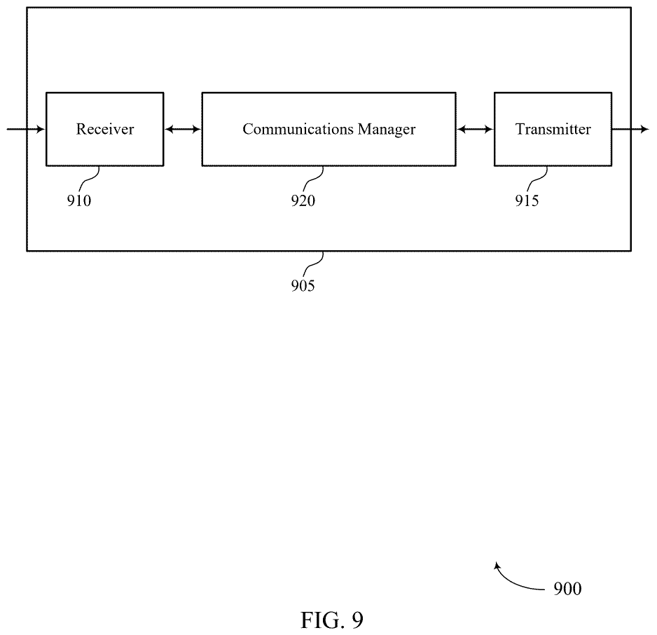

FIG. 9 shows a block diagram 900 of a device 905 that supports power efficient uplink scheduling in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of power efficient uplink scheduling as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting an indication of a configuration of a reduced peak throughput mode for uplink communications from a UE, the reduced peak throughput mode being indicative of a presence of minimum time gaps between consecutive uplink communications, a lack of A-SRS triggering, and a lack of dynamic grants. The communications manager 920 is capable of, configured to, or operable to support a means for outputting, in accordance with the configuration of the reduced peak throughput mode, control signaling that schedules one or more uplink messages. The communications manager 920 is capable of, configured to, or operable to support a means for obtaining the one or more uplink messages based on the control signaling.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, more efficient utilization of communication resources, improved device coordination, improved coordination between uplink and downlink power efficient scheduling, and increased battery life.

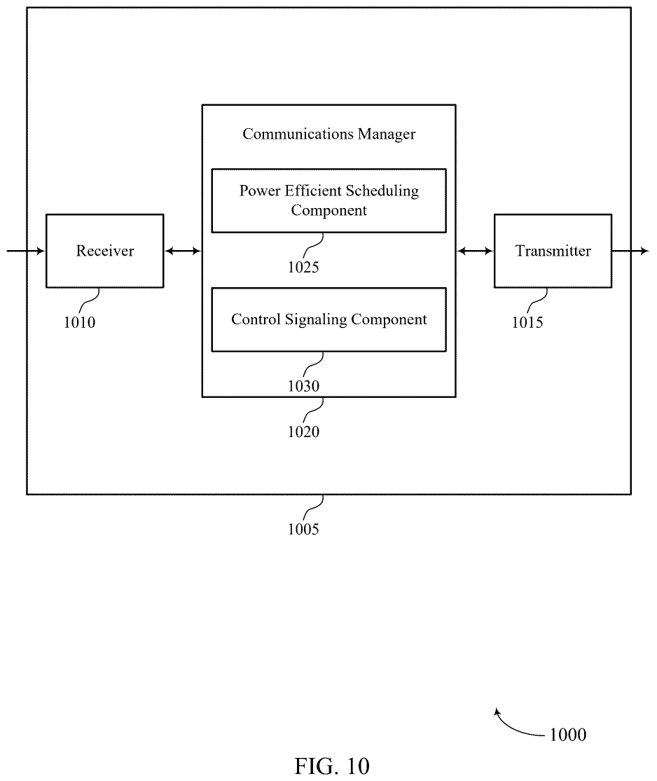

FIG. 10 shows a block diagram 1000 of a device 1005 that supports power efficient uplink scheduling in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of power efficient uplink scheduling as described herein. For example, the communications manager 1020 may include a power efficient scheduling component 1025 a control signaling component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The power efficient scheduling component 1025 is capable of, configured to, or operable to support a means for outputting an indication of a configuration of a reduced peak throughput mode for uplink communications from a UE, the reduced peak throughput mode being indicative of a presence of minimum time gaps between consecutive uplink communications, a lack of A-SRS triggering, and a lack of dynamic grants. The control signaling component 1030 is capable of, configured to, or operable to support a means for outputting, in accordance with the configuration of the reduced peak throughput mode, control signaling that schedules one or more uplink messages. The power efficient scheduling component 1025 is capable of, configured to, or operable to support a means for obtaining the one or more uplink messages based on the control signaling.

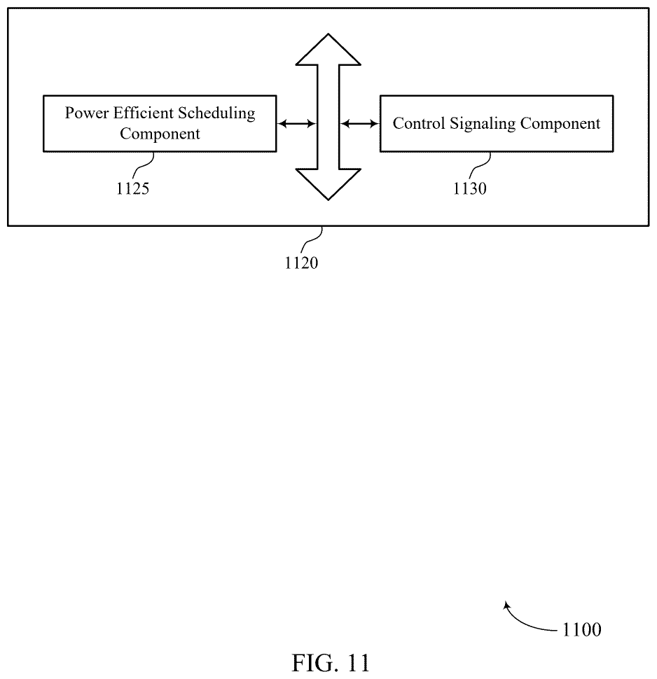

FIG. 11 shows a block diagram 1100 of a communications manager 1120 that supports power efficient uplink scheduling in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of power efficient uplink scheduling as described herein. For example, the communications manager 1120 may include a power efficient scheduling component 1125 a control signaling component 1130, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The power efficient scheduling component 1125 is capable of, configured to, or operable to support a means for outputting an indication of a configuration of a reduced peak throughput mode for uplink communications from a UE, the reduced peak throughput mode being indicative of a presence of minimum time gaps between consecutive uplink communications, a lack of A-SRS triggering, and a lack of dynamic grants. The control signaling component 1130 is capable of, configured to, or operable to support a means for outputting, in accordance with the configuration of the reduced peak throughput mode, control signaling that schedules one or more uplink messages. In some examples, the power efficient scheduling component 1125 is capable of, configured to, or operable to support a means for obtaining the one or more uplink messages based on the control signaling.

In some examples, to support outputting the indication of the configuration of the reduced peak throughput mode, the power efficient scheduling component 1125 is capable of, configured to, or operable to support a means for outputting one or more messages indicative of a lack of aperiodic sounding reference signal (A-SRS) scheduling, or an A-SRS scheduling having a time delay between downlink control signaling and a scheduled uplink transmission that is greater than a minimum scheduling offset.

In some examples, to support outputting the indication of the configuration of the reduced peak throughput mode, the power efficient scheduling component 1125 is capable of, configured to, or operable to support a means for outputting one or more messages indicative of a P-SRS scheduling that is in accordance with the reduced peak throughput mode.

In some examples, the lack of dynamic grants includes at least one of a lack of dynamic grant scheduling, or a dynamic grant scheduling having a time delay between downlink control signaling and a scheduled uplink transmission that is greater than a minimum scheduling offset. In some examples, to support outputting the indication of the configuration of the reduced peak throughput mode, the power efficient scheduling component 1125 is capable of, configured to, or operable to support a means for outputting one or more messages indicative of that a threshold time gap is satisfied between consecutive scheduled uplink grants.

In some examples, to support outputting the indication of the configuration of the reduced peak throughput mode, the power efficient scheduling component 1125 is capable of, configured to, or operable to support a means for outputting one or more messages indicative of a configured grant scheduling with a lack of retransmissions, or a configured grant scheduling with retransmissions and a time delay between downlink control signaling and a scheduled uplink transmission that is greater than a minimum scheduling offset.

In some examples, the power efficient scheduling component 1125 is capable of, configured to, or operable to support a means for outputting an indication of an initial resource allocation for transmission of the one or more uplink messages, where the control signaling that schedules the one or more uplink messages indicates a resource allocation within the initial resource allocation. In some examples, the initial resource allocation includes a bandwidth part allocation or a physical resource block segment.

In some examples, to support outputting the indication of the configuration of the reduced peak throughput mode, the power efficient scheduling component 1125 is capable of, configured to, or operable to support a means for outputting one or more SRS trigger messages that trigger wideband SRS transmission by the UE, where a quantity of consecutive SRS trigger messages outputted as part of the one or more SRS trigger messages is less than a threshold quantity. In some examples, to support outputting one or more SRS trigger messages, the power efficient scheduling component 1125 is capable of, configured to, or operable to support a means for outputting discontinuous SRS trigger messages, where each SRS trigger message is separated by a threshold quantity of slots.

In some examples, to support outputting the indication of the configuration of the reduced peak throughput mode, the power efficient scheduling component 1125 is capable of, configured to, or operable to support a means for outputting one or more messages indicative of an uplink preparation timeline for the UE in the reduced peak throughput mode being greater than a default uplink preparation timeline for the UE in a non-reduced peak throughput mode.

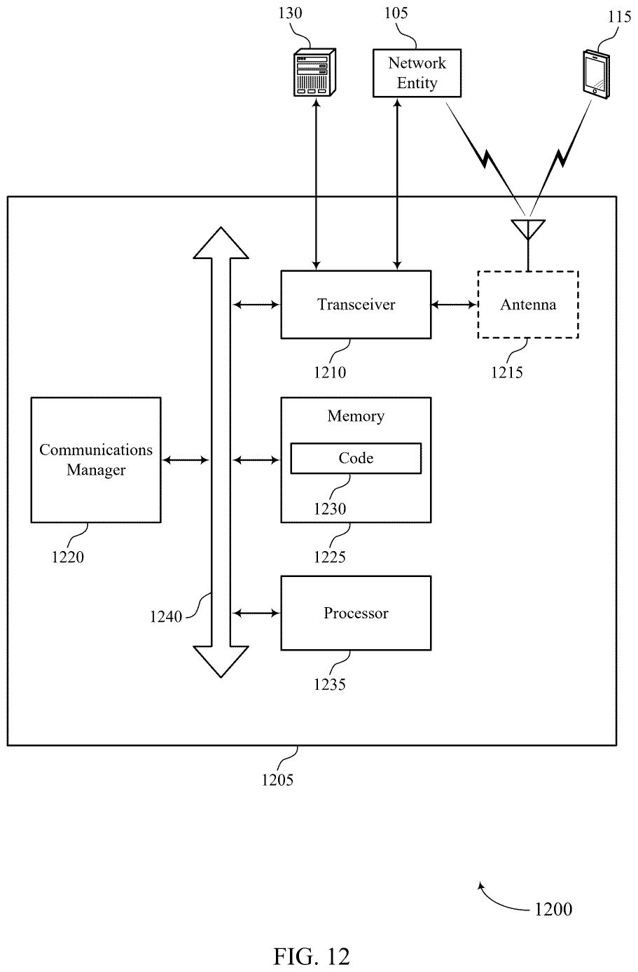

FIG. 12 shows a diagram of a system 1200 including a device 1205 that supports power efficient uplink scheduling in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting power efficient uplink scheduling). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting an indication of a configuration of a reduced peak throughput mode for uplink communications from a UE, the reduced peak throughput mode being indicative of a presence of minimum time gaps between consecutive uplink communications, a lack of A-SRS triggering, and a lack of dynamic grants. The communications manager 1220 is capable of, configured to, or operable to support a means for outputting, in accordance with the configuration of the reduced peak throughput mode, control signaling that schedules one or more uplink messages. The communications manager 1220 is capable of, configured to, or operable to support a means for obtaining the one or more uplink messages based on the control signaling.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, improved utilization of processing capability, improved UE baseband function, and improved coordination between uplink and downlink power efficient scheduling.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of power efficient uplink scheduling as described herein, or the at least one processor 1235 and the at least one memory 1225 may be otherwise configured to, individually or collectively, perform or support such operations.

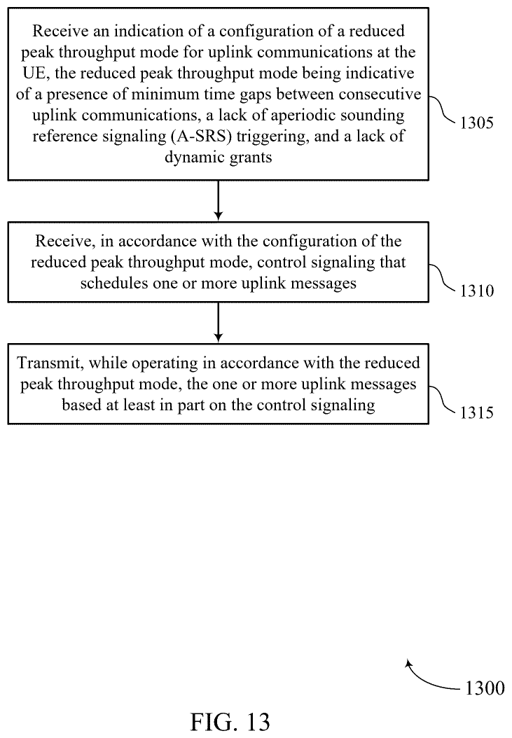

FIG. 13 shows a flowchart illustrating a method 1300 that supports power efficient uplink scheduling in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a configuration of a reduced peak throughput mode for uplink communications at the UE, the reduced peak throughput mode being indicative of a presence of minimum time gaps between consecutive uplink communications, a lack of A-SRS triggering, and a lack of dynamic grants. The operations of 1305 may be performed in accordance with examples as disclosed herein. In some examples, aspects of the operations of 1305 may be performed by a power efficient configuration component 725 as described with reference to FIG. 7.

At 1310, the method may include receiving, in accordance with the configuration of the reduced peak throughput mode, control signaling that schedules one or more uplink messages. The operations of 1310 may be performed in accordance with examples as disclosed herein. In some examples, aspects of the operations of 1310 may be performed by an uplink scheduling component 730 as described with reference to FIG. 7.

At 1315, the method may include transmitting, while operating in accordance with the reduced peak throughput mode, the one or more uplink messages based at least in part on the control signaling. The operations of 1315 may be performed in accordance with examples as disclosed herein. In some examples, aspects of the operations of 1315 may be performed by an uplink scheduling component 730 as described with reference to FIG. 7.

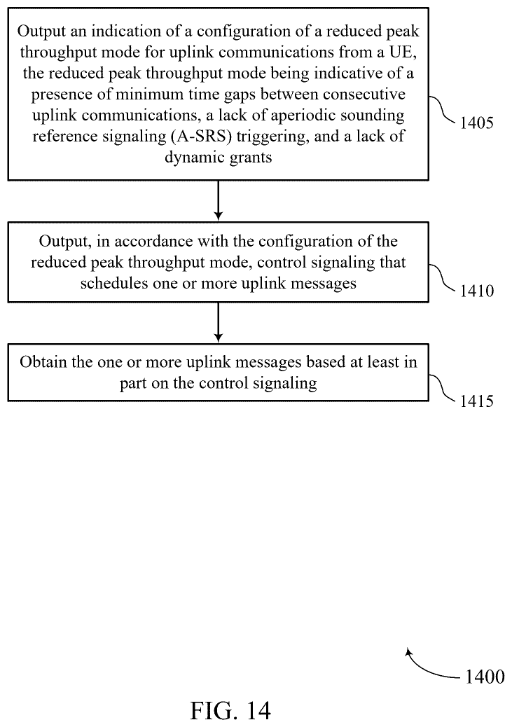

FIG. 14 shows a flowchart illustrating a method 1400 that supports power efficient uplink scheduling in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting an indication of a configuration of a reduced peak throughput mode for uplink communications from a UE, the reduced peak throughput mode being indicative of a presence of minimum time gaps between consecutive uplink communications, a lack of A-SRS triggering, and a lack of dynamic grants. The operations of 1405 may be performed in accordance with examples as disclosed herein. In some examples, aspects of the operations of 1405 may be performed by a power efficient scheduling component 1125 as described with reference to FIG. 11.

At 1410, the method may include outputting, in accordance with the configuration of the reduced peak throughput mode, control signaling that schedules one or more uplink messages. The operations of 1410 may be performed in accordance with examples as disclosed herein. In some examples, aspects of the operations of 1410 may be performed by a control signaling component 1130 as described with reference to FIG. 11.

At 1415, the method may include obtaining the one or more uplink messages based at least in part on the control signaling. The operations of 1415 may be performed in accordance with examples as disclosed herein. In some examples, aspects of the operations of 1415 may be performed by a power efficient scheduling component 1125 as described with reference to FIG. 11.

The following provides an overview of aspects of the present disclosure:

Aspect 1: A method for wireless communications at a UE, comprising: receiving an indication of a configuration of a reduced peak throughput mode for uplink communications at the UE, the reduced peak throughput mode being indicative of a presence of minimum time gaps between consecutive uplink communications, a lack of A-SRS triggering, and a lack of dynamic grants; receiving, in accordance with the configuration of the reduced peak throughput mode, control signaling that schedules one or more uplink messages; and transmitting, while operating in accordance with the reduced peak throughput mode, the one or more uplink messages based at least in part on the control signaling.

Aspect 2: The method of aspect 1, wherein receiving the indication of the configuration of the reduced peak throughput mode comprises: receiving one or more messages indicative of a lack of A-SRS scheduling, or an A-SRS scheduling having a time delay between downlink control signaling and a scheduled uplink transmission that is greater than a minimum scheduling offset.

Aspect 3: The method of aspect 2, wherein the minimum scheduling offset for the A-SRS scheduling is based at least in part on one or more capabilities of the UE, the one or more capabilities comprising at least one of a UAI signaling capability, a MAC-CE signaling capability, or a UCI signaling capability.

Aspect 4: The method of any of aspects 1 through 3, wherein receiving the indication of the configuration of the reduced peak throughput mode comprises: receiving one or more messages indicative of a P-SRS scheduling that is in accordance with the reduced peak throughput mode.

Aspect 5: The method of any of aspects 1 through 4, wherein the lack of dynamic grants comprises at least one of a lack of dynamic grant scheduling, or a dynamic grant scheduling having a time delay between downlink control signaling and a scheduled uplink transmission that is greater than a minimum scheduling offset.

Aspect 6: The method of aspect 5, wherein the minimum scheduling offset for the dynamic grant scheduling is based at least in part on one or more capabilities of the UE, the one or more capabilities comprising at least one of a UAI signaling capability, a MAC-CE signaling capability, or an UCI signaling capability.

Aspect 7: The method of any of aspects 1 through 6, wherein receiving the indication of the configuration of the reduced peak throughput mode comprises: receiving one or more messages indicative of that a threshold time gap is satisfied between consecutive scheduled uplink grants.

Aspect 8: The method of any of aspects 1 through 7, wherein receiving the indication of the configuration of the reduced peak throughput mode comprises: receiving one or more messages indicative of a configured grant scheduling with a lack of retransmissions, or a configured grant scheduling with retransmissions and a time delay between downlink control signaling and a scheduled uplink transmission that is greater than a minimum scheduling offset.

Aspect 9: The method of any of aspects 1 through 8, further comprising: receiving an indication of an initial resource allocation for transmission of the one or more uplink messages, wherein the control signaling that schedules the one or more uplink messages indicates a resource allocation within the initial resource allocation.

Aspect 10: The method of aspect 9, wherein the initial resource allocation comprises a BWP allocation or a physical resource block segment.

Aspect 11: The method of any of aspects 1 through 10, wherein receiving the indication of the configuration of the reduced peak throughput mode comprises: receiving one or more SRS trigger messages that trigger wideband SRS transmission by the UE, wherein a quantity of consecutive SRS trigger messages received as part of the one or more SRS trigger messages is less than a threshold quantity.

Aspect 12: The method of aspect 11, wherein receiving one or more SRS trigger messages comprises: receiving discontinuous SRS trigger messages based at least in part on one or more capabilities of the UE, wherein each SRS trigger message is separated by a threshold quantity of slots.

Aspect 13: The method of any of aspects 1 through 12, wherein receiving the control signaling that schedules the one or more uplink messages comprises: receiving control signaling that schedules one or more uplink configured grant messages on a first cell and one or more SRS messages on a second cell, wherein transmitting the one or more uplink messages comprises: transmitting the one or more SRS messages on the first cell based at least in part on a threshold timeline being satisfied for cancellation of the one or more uplink configured grant messages, wherein the one or more uplink configured grant messages are dropped in accordance with the reduced peak throughput mode.

Aspect 14: The method of any of aspects 1 through 13, wherein receiving the control signaling that schedules the one or more uplink messages comprises: receiving control signaling that schedules one or more SRS messages on a first cell and one or more channel state information messages or uplink configured grant messages on a second cell, wherein transmitting the one or more uplink messages comprises: transmitting the one or more channel state information messages or uplink configured grant messages on the second cell, wherein the one or more SRS messages are dropped in accordance with the reduced peak throughput mode.

Aspect 15: The method of any of aspects 1 through 14, wherein receiving the control signaling that schedules the one or more uplink messages comprises: receiving control signaling that schedules one or more SRS messages on a first cell and one or more dynamic grant uplink messages on a second cell, wherein transmitting the one or more uplink messages comprises: transmitting the one or more dynamic grant uplink messages on the second cell, wherein the one or more SRS messages are dropped in accordance with the reduced peak throughput mode.

Aspect 16: The method of any of aspects 1 through 15, wherein receiving the control signaling that schedules the one or more uplink messages comprises: receiving control signaling that schedules one or more SRS messages on a first cell and one or more uplink control messages on a second cell, wherein transmitting the one or more uplink messages comprises: transmitting the one or more uplink control messages on the second cell, wherein the one or more SRS messages are dropped in accordance with the reduced peak throughput mode.

Aspect 17: The method of any of aspects 1 through 16, wherein receiving the control signaling that schedules the one or more uplink messages comprises: receiving control signaling that schedules one or more SRS messages on a first cell and one or more uplink messages on a second cell, wherein transmitting the one or more uplink messages comprises: transmitting the one or more uplink messages on the second cell, wherein transmission of the one or more SRS messages is delayed one or more transmission cycles based at least in part on the one or more uplink messages having a higher priority than the one or more SRS messages.

Aspect 18: The method of any of aspects 1 through 17, wherein receiving the indication of the configuration of the reduced peak throughput mode comprises: receiving one or more messages indicative of an uplink preparation timeline for the UE in the reduced peak throughput mode being greater than a default uplink preparation timeline for the UE in a non-reduced peak throughput mode.

Aspect 19: The method of aspect 18, wherein the uplink preparation timeline in the reduced peak throughput mode comprises the default uplink preparation timeline plus an applied timing offset.

Aspect 20: The method of any of aspects 1 through 19, wherein the presence of minimum time gaps between consecutive uplink communications is based at least in part on semi-static grants with the lack of dynamic grants, the lack of A-SRS triggering, or both.

Aspect 21: A method for wireless communications at a network entity, comprising: outputting an indication of a configuration of a reduced peak throughput mode for uplink communications from a UE, the reduced peak throughput mode being indicative of a presence of minimum time gaps between consecutive uplink communications, a lack of A-SRS triggering, and a lack of dynamic grants; outputting, in accordance with the configuration of the reduced peak throughput mode, control signaling that schedules one or more uplink messages; and obtaining the one or more uplink messages based at least in part on the control signaling.

Aspect 22: The method of aspect 21, wherein outputting the indication of the configuration of the reduced peak throughput mode comprises: outputting one or more messages indicative of a lack of A-SRS scheduling, or an A-SRS scheduling having a time delay between downlink control signaling and a scheduled uplink transmission that is greater than a minimum scheduling offset.

Aspect 23: The method of any of aspects 21 through 22, wherein outputting the indication of the configuration of the reduced peak throughput mode comprises: outputting one or more messages indicative of a P-SRS scheduling that is in accordance with the reduced peak throughput mode.

Aspect 24: The method of any of aspects 21 through 23, wherein the lack of dynamic grants comprises at least one of a lack of dynamic grant scheduling, or a dynamic grant scheduling having a time delay between downlink control signaling and a scheduled uplink transmission that is greater than a minimum scheduling offset.

Aspect 25: The method of any of aspects 21 through 24, wherein outputting the indication of the configuration of the reduced peak throughput mode comprises: outputting one or more messages indicative of that a threshold time gap is satisfied between consecutive scheduled uplink grants.

Aspect 26: The method of any of aspects 21 through 25, wherein outputting the indication of the configuration of the reduced peak throughput mode comprises: outputting one or more messages indicative of a configured grant scheduling with a lack of retransmissions, or a configured grant scheduling with retransmissions and a time delay between downlink control signaling and a scheduled uplink transmission that is greater than a minimum scheduling offset.

Aspect 27: The method of any of aspects 21 through 26, further comprising: outputting an indication of an initial resource allocation for transmission of the one or more uplink messages, wherein the control signaling that schedules the one or more uplink messages indicates a resource allocation within the initial resource allocation.

Aspect 28: The method of aspect 27, wherein the initial resource allocation comprises a bandwidth part allocation or a physical resource block segment.

Aspect 29: The method of any of aspects 21 through 28, wherein outputting the indication of the configuration of the reduced peak throughput mode comprises: outputting one or more SRS trigger messages that trigger wideband SRS transmission by the UE, wherein a quantity of consecutive SRS trigger messages outputted as part of the one or more SRS trigger messages is less than a threshold quantity.

Aspect 30: The method of aspect 29, wherein outputting one or more SRS trigger messages comprises: outputting discontinuous SRS trigger messages, wherein each SRS trigger message is separated by a threshold quantity of slots.

Aspect 31: The method of any of aspects 21 through 30, wherein outputting the indication of the configuration of the reduced peak throughput mode comprises: outputting one or more messages indicative of an uplink preparation timeline for the UE in the reduced peak throughput mode being greater than a default uplink preparation timeline for the UE in a non-reduced peak throughput mode.

Aspect 32: A UE for wireless communications, comprising one or more memories storing processor-executable code, and one or more processors coupled with the one or more memories and individually or collectively operable to execute the code to cause the UE to perform a method of any of aspects 1 through 20.

Aspect 33: A UE for wireless communications, comprising at least one means for performing a method of any of aspects 1 through 20.

Aspect 34: A non-transitory computer-readable medium storing code for wireless communications, the code comprising instructions executable by one or more processors to perform a method of any of aspects 1 through 20.

Aspect 35: A network entity for wireless communications, comprising one or more memories storing processor-executable code, and one or more processors coupled with the one or more memories and individually or collectively operable to execute the code to cause the network entity to perform a method of any of aspects 21 through 31.

Aspect 36: A network entity for wireless communications, comprising at least one means for performing a method of any of aspects 21 through 31.

Aspect 37: A non-transitory computer-readable medium storing code for wireless communications, the code comprising instructions executable by one or more processors to perform a method of any of aspects 21 through 31.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indication of a configuration of a reduced peak throughput mode for uplink communications at the UE, the reduced peak throughput mode being indicative of a presence of minimum time gaps between consecutive uplink communications, a lack of aperiodic sounding reference signaling (A-SRS) triggering, and a lack of dynamic grants;
receive, in accordance with the configuration of the reduced peak throughput mode, control signaling that schedules one or more uplink messages; and
transmit, while operating in accordance with the reduced peak throughput mode, the one or more uplink messages based at least in part on the control signaling.

2. The UE of claim 1, wherein, to receive the indication of the configuration of the reduced peak throughput mode, the one or more processors are individually or collectively operable to execute the code to cause the UE to:
receive one or more messages indicative of a lack of A-SRS scheduling, or an A-SRS scheduling having a time delay between downlink control signaling and a scheduled uplink transmission that is greater than a minimum scheduling offset.

3. The UE of claim 2, wherein the minimum scheduling offset for the A-SRS scheduling is based at least in part on one or more capabilities of the UE, the one or more capabilities comprising at least one of a UE assistance information (UAI) signaling capability, a medium access control-control element (MAC-CE) signaling capability, or an uplink control information (UCI) signaling capability.

4. The UE of claim 1, wherein, to receive the indication of the configuration of the reduced peak throughput mode, the one or more processors are individually or collectively operable to execute the code to cause the UE to:
receive one or more messages indicative of a periodic sounding reference signal (P-SRS) scheduling that is in accordance with the reduced peak throughput mode.

5. The UE of claim 1, wherein the lack of dynamic grants comprises at least one of:
a lack of dynamic grant scheduling; or
a dynamic grant scheduling having a time delay between downlink control signaling and a scheduled uplink transmission that is greater than a minimum scheduling offset.

6. The UE of claim 5, wherein the minimum scheduling offset for the dynamic grant scheduling is based at least in part on one or more capabilities of the UE, the one or more capabilities comprising at least one of a UE assistance information (UAI) signaling capability, a medium access control-control element (MAC-CE) signaling capability, or an uplink control information (UCI) signaling capability.

7. The UE of claim 1, wherein, to receive the indication of the configuration of the reduced peak throughput mode, the one or more processors are individually or collectively operable to execute the code to cause the UE to:
receive one or more messages that indicate a threshold time gap being satisfied between consecutive scheduled uplink grants.

8. The UE of claim 1, wherein, to receive the indication of the configuration of the reduced peak throughput mode, the one or more processors are individually or collectively operable to execute the code to cause the UE to:
receive one or more messages indicative of a configured grant scheduling with a lack of retransmissions, or a configured grant scheduling with retransmissions and a time delay between downlink control signaling and a scheduled uplink transmission that is greater than a minimum scheduling offset.

9. The UE of claim 1, wherein the one or more processors are individually or collectively further operable to execute the code to cause the UE to:
receive an indication of an initial resource allocation for transmission of the one or more uplink messages, wherein the control signaling that schedules the one or more uplink messages indicates a resource allocation within the initial resource allocation.

10. The UE of claim 9, wherein the initial resource allocation comprises a bandwidth part allocation or a physical resource block segment.

11. The UE of claim 1, wherein, to receive the indication of the configuration of the reduced peak throughput mode, the one or more processors are individually or collectively operable to execute the code to cause the UE to:
receive one or more sounding reference signal (SRS) trigger messages that trigger wideband SRS transmission by the UE, wherein a quantity of consecutive SRS trigger messages received as part of the one or more SRS trigger messages is less than a threshold quantity.

12. The UE of claim 11, wherein, to receive one or more SRS trigger messages, the one or more processors are individually or collectively operable to execute the code to cause the UE to:
receive discontinuous SRS trigger messages based at least in part on one or more capabilities of the UE, wherein each SRS trigger message is separated by a threshold quantity of slots.

13. The UE of claim 1, wherein, to receive the control signaling that schedules the one or more uplink messages, the one or more processors are individually or collectively operable to execute the code to cause the UE to:
receive control signaling that schedules one or more uplink configured grant messages on a first cell and one or more sounding reference signal (SRS) messages on a second cell, wherein transmitting the one or more uplink messages comprises:
transmit the one or more SRS messages on the first cell based at least in part on a threshold timeline being satisfied for cancellation of the one or more uplink configured grant messages, wherein the one or more uplink configured grant messages are dropped in accordance with the reduced peak throughput mode.

14. The UE of claim 1, wherein, to receive the control signaling that schedules the one or more uplink messages, the one or more processors are individually or collectively operable to execute the code to cause the UE to:
receive control signaling that schedules one or more sounding reference signal (SRS) messages on a first cell and one or more channel state information messages or the uplink configured grant messages on a second cell, wherein, to transmit the one or more uplink messages, the one or more processors are individually or collectively operable to execute the code to cause the UE to:
transmit the one or more channel state information messages or uplink configured grant messages on the second cell, wherein the one or more SRS messages are dropped in accordance with the reduced peak throughput mode.

15. The UE of claim 1, wherein, to receive the control signaling that schedules the one or more uplink messages, the one or more processors are individually or collectively operable to execute the code to cause the UE to:
receive control signaling that schedules one or more sounding reference signal (SRS) messages on a first cell and one or more dynamic grant uplink messages on a second cell, wherein, to transmit the one or more uplink messages, the one or more processors are individually or collectively operable to execute the code to cause the UE to:
transmit the one or more dynamic grant uplink messages on the second cell, wherein the one or more SRS messages are dropped in accordance with the reduced peak throughput mode.

16. The UE of claim 1, wherein, to receive the control signaling that schedules the one or more uplink messages, the one or more processors are individually or collectively operable to execute the code to cause the UE to:
receive control signaling that schedules one or more sounding reference signal (SRS) messages on a first cell and one or more uplink control messages on a second cell, wherein, to transmit the one or more uplink messages, the one or more processors are individually or collectively operable to execute the code to cause the UE to:
transmit the one or more uplink control messages on the second cell, wherein the one or more SRS messages are dropped in accordance with the reduced peak throughput mode.

17. The UE of claim 1, wherein, to receive the control signaling that schedules the one or more uplink messages, the one or more processors are individually or collectively operable to execute the code to cause the UE to:
receive control signaling that schedules one or more sounding reference signal (SRS) messages on a first cell and one or more uplink messages on a second cell, wherein, to transmit the one or more uplink messages, the one or more processors are individually or collectively operable to execute the code to cause the UE to:
transmit the one or more uplink messages on the second cell, wherein transmission of the one or more SRS messages is delayed one or more transmission cycles based at least in part on the one or more uplink messages having a higher priority than the one or more SRS messages.

18. The UE of claim 1, wherein, to receive the indication of the configuration of the reduced peak throughput mode, the one or more processors are individually or collectively operable to execute the code to cause the UE to:
receive one or more messages indicative of an uplink preparation timeline for the UE in the reduced peak throughput mode being greater than a default uplink preparation timeline for the UE in a non-reduced peak throughput mode.

19. The UE of claim 18, wherein the uplink preparation timeline in the reduced peak throughput mode comprises the default uplink preparation timeline plus an applied timing offset.

20. The UE of claim 1, wherein the presence of minimum time gaps between consecutive uplink communications is based at least in part on semi-static grants with the lack of dynamic grants, the lack of aperiodic sounding reference signaling (A-SRS) triggering, or both.

21. A network entity, comprising:
one or more memories storing processor-executable code; and
one or more processors coupled with the one or more memories and individually or collectively operable to execute the code to cause the network entity to:
output an indication of a configuration of a reduced peak throughput mode for uplink communications from a user equipment (UE), the reduced peak throughput mode being indicative of a presence of minimum time gaps between consecutive uplink communications, a lack of aperiodic sounding reference signaling (A-SRS) triggering, and a lack of dynamic grants;
output, in accordance with the configuration of the reduced peak throughput mode, control signaling that schedules one or more uplink messages; and
obtain the one or more uplink messages based at least in part on the control signaling.

22. The network entity of claim 21, wherein, to output the indication of the configuration of the reduced peak throughput mode, the one or more processors are individually or collectively operable to execute the code to cause the network entity to:
output one or more messages indicative of a lack of aperiodic sounding reference signal (A-SRS) scheduling, or an A-SRS scheduling having a time delay between downlink control signaling and a scheduled uplink transmission that is greater than a minimum scheduling offset.

23. The network entity of claim 21, wherein, to output the indication of the configuration of the reduced peak throughput mode, the one or more processors are individually or collectively operable to execute the code to cause the network entity to:
output one or more messages indicative of a periodic sounding reference signal (P-SRS) scheduling that is in accordance with the reduced peak throughput mode.

24. The network entity of claim 21, wherein, to output the indication of the configuration of the reduced peak throughput mode, the one or more processors are individually or collectively operable to execute the code to cause the network entity to:
output one or more messages that indicate a threshold time gap being satisfied between consecutive scheduled uplink grants.

25. The network entity of claim 21, wherein, to output the indication of the configuration of the reduced peak throughput mode, the one or more processors are individually or collectively operable to execute the code to cause the network entity to:
output one or more messages indicative of a configured grant scheduling with a lack of retransmissions, or a configured grant scheduling with retransmissions and a time delay between downlink control signaling and a scheduled uplink transmission that is greater than a minimum scheduling offset.

26. The network entity of claim 21, wherein the one or more processors are individually or collectively further operable to execute the code to cause the network entity to:
output an indication of an initial resource allocation for transmission of the one or more uplink messages, wherein the control signaling that schedules the one or more uplink messages indicates a resource allocation within the initial resource allocation.

27. The network entity of claim 21, wherein, to output the indication of the configuration of the reduced peak throughput mode, the one or more processors are individually or collectively operable to execute the code to cause the network entity to:
output one or more sounding reference signal (SRS) trigger messages that trigger wideband SRS transmission by the UE, wherein a quantity of consecutive SRS trigger messages outputted as part of the one or more SRS trigger messages is less than a threshold quantity.

28. The network entity of claim 21, wherein, to output the indication of the configuration of the reduced peak throughput mode, the one or more processors are individually or collectively operable to execute the code to cause the network entity to:
output one or more messages indicative of an uplink preparation timeline for the UE in the reduced peak throughput mode being greater than a default uplink preparation timeline for the UE in a non-reduced peak throughput mode.

29. A method for wireless communications at a user equipment (UE), comprising:
receiving an indication of a configuration of a reduced peak throughput mode for uplink communications at the UE, the reduced peak throughput mode being indicative of a presence of minimum time gaps between consecutive uplink communications, a lack of aperiodic sounding reference signaling (A-SRS) triggering, and a lack of dynamic grants;
receiving, in accordance with the configuration of the reduced peak throughput mode, control signaling that schedules one or more uplink messages; and
transmitting, while operating in accordance with the reduced peak throughput mode, the one or more uplink messages based at least in part on the control signaling.

30. A method for wireless communications at a network entity, comprising:
outputting an indication of a configuration of a reduced peak throughput mode for uplink communications from a user equipment (UE), the reduced peak throughput mode being indicative of a presence of minimum time gaps between consecutive uplink communications, a lack of aperiodic sounding reference signaling (A-SRS) triggering, and a lack of dynamic grants;
outputting, in accordance with the configuration of the reduced peak throughput mode, control signaling that schedules one or more uplink messages; and
obtaining the one or more uplink messages based at least in part on the control signaling.
